(19) United States
(12) Patent Application Publication
(10) Pub. No.: US 2008/0207316 A1
(43) Pub. Date: Aug. 28, 2008

(54) Method and system for using online entertainment to promote goods, services, activities and events

(76) Inventors: James Mark Burnett, Malibu, CA (US); Ted Smith, Los Angeles, CA (US)

Correspondence Address: THE HECKER LAW GROUP, 1925 CENTURY PARK EAST, SUITE 2300, LOS ANGELES, CA, 90067, US

(21) Appl. No.: 11/973,311

(22) Filed: Oct. 4, 2007

Related U.S. Application Data
(60) Provisional application No. 60/863,958, filed on Nov. 1, 2006.

(51) Int. Cl. A63F 9/24; G06Q 30/00

(52) U.S. Cl. 463/29; 705/14

(57) ABSTRACT

The present invention is a method and system for online selection of contestants for online and offline competitions that uses objective selection criteria and allows the participation of members of the general public. It also provides an effective marketing and revenue generating mechanism as part of the contestant selection process. In one or more embodiments, a series of online challenges are presented to potential contestants (sometimes referred to herein as “participants.”) In one or more embodiments, challenges are designed to be entertaining (i.e. fun to participate in) as well as goal achieving (i.e means to become a contestant in a competition and/or win a prize). In one or more embodiments, one or more of the challenges integrates a sponsor's product or service into the subject matter (i.e. structure, process, and/or content) of a challenge, and/or requires a participant to obtain information about a sponsor's product or service to complete the challenge. In one or more embodiments, one or more online preliminary challenges are presented over a period of time. Successful completion of the online preliminary challenges permits a participant to compete in one or more subsequent challenges. In one or more embodiments, participants who are successful in completing the subsequent challenge(s) are selected to participate in an associated competition. In one or more embodiments, one or more of the challenges require a participant to obtain information about a sponsor's product or advertisement to complete the challenge, thereby directing the attention of participants to the sponsor's product or service. In one or more embodiments, the invention promotes interaction of participants with new media (i.e. the internet), traditional media (i.e. television, film and print media), and real world events (i.e. an offline competition).

### CROSS REFERENCE TO RELATED PATENT APPLICATION

This patent application claims the benefit of the filing date of U.S. Provisional Patent Application Ser. No. 60/863,958 filed Nov. 1, 2006 entitled “Method and System for Online Selection of Contestants for Competitions” the specification of which is incorporated by reference herein.

### FIELD OF THE INVENTION

This invention relates to the field of online entertainment, and in particular to a method and system for using online entertainment to promote goods, services, and participation in offline activities and events.

### BACKGROUND OF THE INVENTION

The internet has become a major venue for advertising. As people spend more time online, the effectiveness of traditional venues for advertising, such as television and radio, has started to decrease, and advertisers are doing more advertising online. The typical online advertisement is a banner ad that is displayed when an internet user visits a website, typically for a reason not directly related to the product or service being advertised. For example, web portals such as yahoo.com and search engines such as google.com are major venues for advertising because they are visited by a large number of internet users.

One problem with typical online advertising is that it presented to a user in a passive manner, and for a short period of time. There is typically little or no emotional involvement by a user in the advertisement.

### SUMMARY OF THE INVENTION

The present invention is a method and system for online selection of contestants for online or offline competitions that uses objective selection criteria and allows the participation by members of the general public. It also provides an effective marketing and revenue generating mechanism as part of the contestant selection process.

As used herein, the term “online” with respect to an activity refers to an activity in which a participant utilizes a device that communicates over a network, such as, for example, a computer, a cellular telephone, a PDA, a GPS locator, or other device that communicates (wired or wirelessly) with a local or global network, such as, for example, the internet. The term “offline” with respect to an activity refers to an activity in which a participant participates in an other than “online” manner, for example though actual, physical presence (for example by participating in an in-person challenge or competition), or by being a passive participant (for example, by being an entrant in a random drawing or sweepstakes). An example of an “online” activity is a person playing a computer game provided by an internet website. An example of an “offline” activity is a person playing a game of chess against another player using a physical chess board or being included in a pool of names from which one or more winners is drawn. With respect to events in which a person actively participates, an “online” activity implies a “virtual” presence (e.g. via an internet connection), while an “offline” activity implies an actual, physical presence.

In one or more embodiments, a series of online challenges are presented to potential contestants (sometimes referred to herein as “participants.”) Examples of challenges include answering questions of particular or general knowledge; solving graphical, word or other puzzles; and successfully completing online games. In one or more embodiments, members of the general public may participate in the challenges by completing an online registration process. Participation may be free, or may require payment of a fee, or may require some other criteria. In one or more embodiments, challenges are designed to be entertaining (i.e. fun to participate in) as well as goal achieving (i.e means to become a contestant in a competition and/or win a prize). In one or more embodiments, one or more of the challenges integrates a sponsor's product or service into the subject matter (i.e. structure, process, and/or content) of the challenge, and/or requires a participant to obtain information about a sponsor's product or service to successfully complete the challenge. The product promotion thus becomes an integral part of the entertainment or goal achieving activity. In that manner, the invention provides an opportunity to promote a sponsor's products, not in the context of a traditional advertisement that is passively presented to a person, but in the context of an entertaining and goal-achieving activity in which the person is actively engaged, and in the context of which he or she has a vested interest in learning information about the sponsor's product to achieve the purpose of activity (i.e. completing the challenge and/or winning a prize).

In one or more embodiments, a first series of challenges comprising one or more online challenges is presented over a period of time. Successful completion of the first series of challenges permits a participant to compete in one or more subsequent challenges, sometimes referred to herein as “selection challenges”. A purpose of the selection challenge(s) is to select contestants who will participate in an online or offline competition, typically for a prize. In one or more embodiments, participants who are successful in completing the selection challenge(s) are selected to participate in the competition. In one or more embodiments, a degree of success is determined by a “score” achieved by the participant in the selection challenge(s). In one or more embodiments, the “score” is the time at which the participant completes the selection challenge(s). In one or more embodiments, participants with the highest scores are selected to participate in the competition.

In one or more embodiments, successful completion of one or more challenges automatically enters a participant in one or more sweepstakes. In one or more embodiments, a sweepstake comprises a random drawing amongst qualifying participants for one or more prizes.

In one or more embodiments, one or more of the challenges requires a participant to obtain information from a off-line event, such as, for example, a movie shown at a movie theatre, for successful completion of the challenge.

In one or more embodiments, a participant must successfully complete one or more online challenges and one or more offline challenges to become a contestant in an online or offline competition.

### BRIEF DESCRIPTION OF THE DRAWINGS

FIG. 1 is a block diagram of an embodiment of the invention.

FIG. 2 is an illustration of a user interface in an embodiment of the invention.

FIG. 3 is an illustration of a user interface in an embodiment of the invention.

FIG. 4 is an illustration of a user interface in an embodiment of the invention.

FIG. 5 is an illustration of a user interface in an embodiment of the invention.

FIG. 6 is an illustration of a user interface in an embodiment of the invention.

FIG. 7 is an illustration of a user interface in an embodiment of the invention.

FIG. 8 is an illustration of a user interface in an embodiment of the invention.

FIG. 9 is an illustration of a user interface in an embodiment of the invention.

FIG. 10 is an illustration of a user interface in an embodiment of the invention.

FIG. 11 is an illustration of a user interface in an embodiment of the invention.

FIG. 12 is an illustration of a user interface in an embodiment of the invention.

FIG. 13 is an illustration of a user interface in an embodiment of the invention.

FIG. 14 is an illustration of a user interface in an embodiment of the invention.

FIG. 15 is an illustration of a user interface in an embodiment of the invention.

FIG. 16 is an illustration of a user interface in an embodiment of the invention.

FIG. 17 is an illustration of a user interface in an embodiment of the invention.

FIG. 18 is an illustration of a user interface in an embodiment of the invention.

FIG. 19 is an illustration of a user interface in an embodiment of the invention.

FIG. 20 is an illustration of a user interface in an embodiment of the invention.

FIG. 21 is an illustration of a user interface in an embodiment of the invention.

FIG. 22 is an illustration of a user interface in an embodiment of the invention.

FIG. 23 is an illustration of a user interface in an embodiment of the invention.

FIG. 24 is an illustration of a user interface in an embodiment of the invention.

FIG. 25 is an illustration of a user interface in an embodiment of the invention.

FIG. 26 is an illustration of a user interface in an embodiment of the invention.

FIG. 27 is an illustration of a user interface in an embodiment of the invention.

FIG. 28 is an illustration of a user interface in an embodiment of the invention.

FIG. 29 is an illustration of a user interface in an embodiment of the invention.

FIG. 30 is an illustration of a user interface in an embodiment of the invention.

FIG. 31 is an illustration of a user interface in an embodiment of the invention.

FIG. 32 is an illustration of a user interface in an embodiment of the invention.

FIG. 33 is an illustration of a user interface in an embodiment of the invention.

FIG. 34 is an illustration of a user interface in an embodiment of the invention.

FIG. 35 is an illustration of a user interface in an embodiment of the invention.

FIG. 36 is an illustration of a user interface in an embodiment of the invention.

FIG. 37 is an illustration of a user interface in an embodiment of the invention.

FIG. 38 is an illustration of a user interface in an embodiment of the invention.

FIG. 39 is an illustration of a user interface in an embodiment of the invention.

FIG. 40 is an illustration of a user interface in an embodiment of the invention.

FIG. 41 is an illustration of a user interface in an embodiment of the invention.

FIG. 42 is an illustration of a user interface in an embodiment of the invention.

FIG. 43 is an illustration of a user interface in an embodiment of the invention.

### DETAILED DESCRIPTION OF THE INVENTION

One or more embodiments of the invention are implemented as an online contest for selection of contestants for offline competition. In one or more embodiments, the offline competition comprises a competition in which a selected contestant competes against one or more other selected contestants in solving challenges. In one or more embodiments, the offline competition comprises a random drawing among selected contestants for one or more prizes. In one or more embodiments, a participant must successfully complete one or more online and one or more offline challenges to become a contestant for the offline competition.

Game shows, contests, and reality competition programs have long been popular forms of entertainment. Examples of popular game shows include Jeopardy and Wheel of Fortune. Examples of popular reality competition programs include The Apprentice, Survivor, and American Idol.

In prior art game shows, contests, and reality competition programs (collectively referred to herein as “competition programs”), contestants are typically selected based on some form of live and/or taped audition.

For example, to become a contestant on Jeopardy, a prospective contestant makes an appointment for an audition, typically held at the studio where the show is taped. At the audition, the prospective contestant first takes a written test. If the prospective contestant passes the written test, the prospective contestant participates in a mock game. If the prospective contestant does well in the mock game, the prospective contestant is placed in a contestant pool from which actual contestants are selected to appear on the show. The prospective contestant may or may not ever appear on the show.

To become a contestant on Survivor, a prospective contestant makes a short video and submits the video to the show producers along with a written statement indicating why the prospective contestant believes he or she would make a desirable Survivor contestant. Subsequently, multi-tiered interviews with prospective contestants are held. If a prospective contestant is provisionally selected as a finalist to appear on the Survivor show, the prospective contestant must also take and pass medical, psychological, and physical examinations.

Prior art selection processes by their nature allow participation by only a small fraction of the general public. They also are not based on objective criteria. As such, a prospective contestant is faced with uncertainty as to what to do to be assured of selection. In addition, prior art selection processes do not provide any effective marketing or other revenue generating opportunities. Instead, they require the expenditure of money that must be paid for out of the revenues generated by the airing of the actual competition program. In the prior art, it is only the competition program itself, not the selection process, that generates revenues for the show's producer.

The invention comprises a system and method for online selection of contestants for online and offline competitions. In the following description, numerous specific details are set forth to provide a thorough description of the invention. For example, descriptions are provided for embodiments of the invention that implemented under the names “Gold Rush™” and “The Flushed Away Underground Adventure™.” It will be apparent, however, to one skilled in the art, that the present invention is not limited to the specific described embodiments and may be practiced without the specific details described herein. In other instances, well-known features have not been described in detail so as not to obscure the invention.

In one or more embodiments, the invention is implemented using internet web pages that present online challenges to members of the general public. A “challenge” as used herein refers to a task that is presented to participants as part of the contestant selection process. Examples of challenges include, but are not limited to, answering questions of particular or general knowledge; solving graphical, word or other puzzles; and successfully completing online games. Specific examples of challenges used in one or more embodiments are described below. However, the invention is not limited to those specific examples.

In one or more embodiments, challenges are designed to promote one or more products or services. For example, a challenge may ask a question about something that occurs in an episode of a television show (thereby promoting the television show), may ask a question about a company or its products (thereby promoting the company and its products), and/or may use a representation of a product or service as an integral part of the challenge (thereby promoting the product or service). In this manner, the contestant selection process acts as an effective marketing and promotional mechanism that can generate significant advertising revenues.

In one or more embodiments, challenges are grouped into a first series of challenges (sometimes referred to as “preliminary challenges”) and a second series of challenges (sometimes referred to as “selection challenges” or “final challenges”). In one or more embodiments, the first series of challenges comprise preliminary challenges that must be solved by a participant to obtain access to one or more selection challenges. In one or more embodiments, selection challenges are used as the basis for selecting contestants for the online or offline competitions, based on the success of participants in solving the selection challenges. In one or more embodiments, the relative success of participants in solving the selection challenges is determined by a “score.” A “score” is whatever criteria is chosen to measure the success of a participant relative to other participants in solving the selection challenges. In one or more embodiments, the time at which a participant successfully solves a selection challenge is utilized as the score for that selection challenge.

In one or more embodiments, the top scoring participants in the applicable selection challenge(s) are invited to participate in an online or offline competition, typically for a valuable prize. If an invited participant accepts the invitation, and meets the general qualifications for participating in the competition, then that participant becomes a contestant in the competition. If an invited participant does not meet the qualifications or does not accept the invitation, the next highest scoring participant (relative to the top scorers that received initial invitations) is invited to be a contestant, again subject to accepting and meeting the required qualifications.

In one or more embodiments, completion of one or more preliminary and/or selection challenges automatically qualifies a participant for participation in a subsequent online or offline competition. For example, in one embodiment, participants who successfully complete a first series of challenges automatically become participants in an random prize drawing, in which one or more prizes are awarded to participants that are randomly selected from a pool of participants that have successfully completed the first series of challenges.

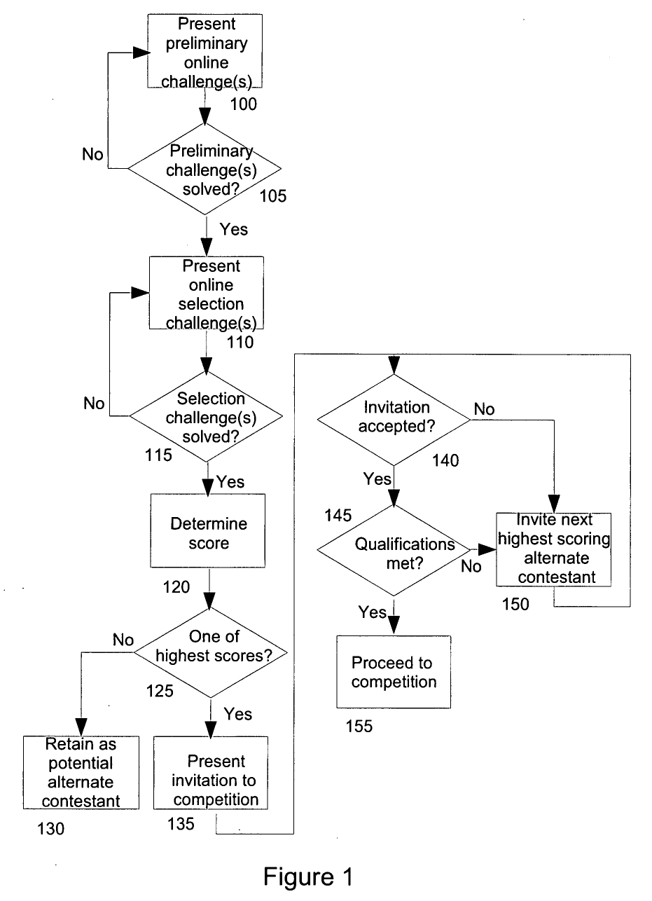

FIG. 1 is a block diagram illustrating the steps in one or more embodiments of a contestant selection process according to the present invention. At step 100, one or more preliminary challenges are made available to participants online. At step 105, a determination is made as to whether a participant has solved the preliminary challenges. If the participant has not yet solved the preliminary challenges, the preliminary challenges continue to be presented to the participant at step 100. If the participant has solved the preliminary challenges, in one or more embodiments, one or more selection challenges are presented to that participant at step 110. In one or more embodiments, completion of the preliminary challenges automatically qualifies the participant to participate in a subsequent competition, such as, for example, a prize drawing.

At step 115, in one or more embodiments, a determination is made as to whether the participant has solved the selection challenge(s). If the participant has not solved the selection challenge(s), the selection challenge(s) continue to be presented to the participant at step 110. If the participant has solved the selection challenge(s), the participant's score for solving the selection challenge(s) is determined at step 120. For example, in one or more embodiments, the time at which the participant solves a selection challenge is used as the score for that selection challenge.

At step 125 a determination is made as to whether the participant's score is one of the top scores for all participants for the applicable selection challenge(s). Various criteria may be used to specify what qualifies as a top score. For example, in one or more embodiments, the participants who are first in time to solve the selection challenges are deemed to be the top scoring participants. In one or more embodiments, the number of top scoring participants is related to the number of contestants that are being sought for the associated competition. For example, if the competition will feature four contestants, the four participants that complete the selection challenge(s) at the earliest time may constitute the highest scorers for purposes of making the determination at step 125.

If the participant is not one of the highest scoring participants, the participant's data is recorded and retained for possible use of the participant as an alternate contestant at step 130. If the participant is one of the highest scoring participants, a conditional invitation is issued to that participant to be a contestant in the offline competition at step 135. The invitation is conditional upon the participant accepting the invitation and meeting contestant qualifications for the offline competition. Such qualifications may include, for example, that the participant is over 18 years of age, is in good physical health, and is not affiliated with the producers of the competition. In one or more embodiments, the invitation to the participant requires acceptance by the participant within a designated time period, such as, for example, 24 hours.

After an invitation has been issued to a participant at step 135, a determination is made at step 140 as to whether the participant has accepted the invitation within any prescribed time period. If the participant has accepted the invitation, a determination is made at step 155 as to whether the participant has met the qualifications for being a contestant in the competition. If the participant has met the required qualifications, the participant is selected as a contestant, and proceeds to the competition.

If it is determined that the participant has not accepted the invitation at step 140, or if it is determined that the participant does not meet the required qualifications for the competition at step 145, then an invitation is made to the next highest-scoring alternate contestant at step 150. Steps 140 and 145 are repeated until the desired number of contestants for the competition have been identified and have met the required qualifications.

One or more embodiments of the invention have been implemented in “Gold Rush™,” an online and offline competition that was launched by AOL in September 2006. In Gold Rush™, members of the general public compete online and offline for cash and/or bars of gold. In Gold Rush™ and one or more other embodiments of the invention, to be able to participate in the online challenges, a person must first fill out a simple registration form and obtain a login name and password. The login name and password are used to keep track of the progress of a participant in solving challenges, and to identify participants who qualify for the offline competitions.

The underlying thematic premise of Gold Rush™ is that a total of $2.2 million dollars worth of gold is hidden at 13 locations across the United States: twelve locations contain $100,000 worth of gold each, while the thirteenth location contains $1,000,000. Over an approximately eight to ten week period, a series of online challenges (sometimes referred to as “rounds”) are held to determine contestants who will compete offline in separate reality competitions for each of the $100,000 prizes. In Gold Rush™, the top three participants in each of the first 12 online rounds compete in an offline $100,000 reality competition for that round. Each winner of a $100,000 reality competition, in addition to receiving $100,000 (which may be awarded in the form or cash, gold or other payment form), also becomes eligible to compete in the final, $1,000,000 reality competition. In addition, a final “round” of online challenges is held to determine six (6) additional contestants for the reality competition for the $1,000,000 prize. The result is the selection of eighteen (18) contestants for the $1,000,000 reality competition.

In one or more embodiments of Gold Rush™, an online round comprises 13 online challenges that are presented to the public over an approximately three day period. In one embodiment, the first six (6) challenges are released the first day, the next four (4) the second day, and the next two (2) the third day. The final (thirteenth) challenge of a round has particular significance—it is the one that determines the contestants that will get to compete in the offline reality competition for the $100,000 prize for that round. The thirteenth challenge, sometimes referred to as a “Gold Challenge,” becomes available to a participant when that participant has solved the first twelve challenges. The first twelve challenges of a round thus constitute “preliminary” challenges whose successful solution entitles a participant to compete in the thirteenth “selection” challenge. In Gold Rush™, the criteria used to select the contestants for the reality competition is the time (i.e. the time of day in an absolute sense) that participants successfully solve the Gold Challenge. In other embodiments, other “success” criteria may be used.

In each of the first twelve (12) rounds of Gold Rush™, three contestants compete for the $100,000 offline competition for that round. The three first finishers of the Gold Challenge for a round are provisionally invited to compete in the $100,000 offline competition for that round, which is held at a different city for each round. To become an actual contestant, a participant who has been provisionally invited must accept the invitation, must meet the qualifications required for contestants, and must travel to the site of the offline competition (the participant's travel and accommodation fees for such travel are typically provided to the participant). The offline competition is recorded and edited, and presented for viewing as a show, either online as a “webisode” or over traditional or other broadcast media.

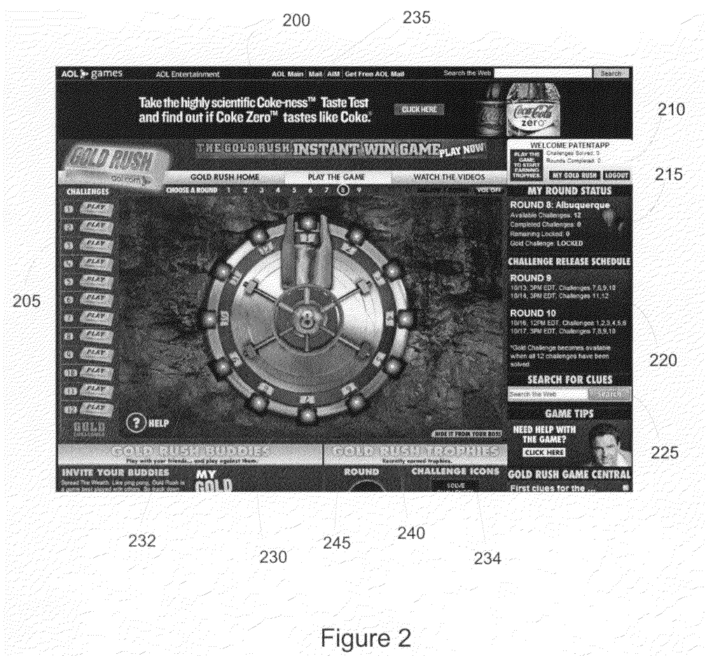

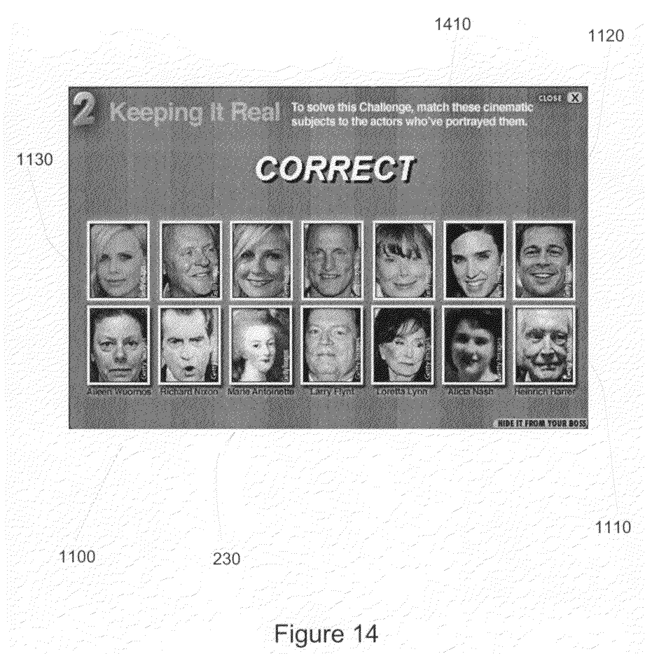

FIGS. 2 to 35 show examples of portions of online interfaces that are presented in an embodiment of Gold Rush™. FIGS. 2 to 35 each show portions of webpages that are displayed when an internet browser (for example Internet Explorer or Firefox) is used to access the Gold Rush™ webpages, for example at www.aol.com/goldrush.

FIG. 2 shows an example of an interface 200 that is presented to an online participant after a participant has logged into the Gold Rush™ website. In the embodiment of FIG. 2, interface 200 comprises a webpage that comprises one or more embedded Flash™ movies. A Flash™ plug-in for the internet browser used by a participant is typically required for the participant to be able to view and participate in the Gold Rush™ challenges.

Interface 200 of FIG. 2 comprises a number of interface elements. The main interface element of interface 200 is central rectangular screen 230. Central screen 230 is the portion of the interface in which the challenges are generally presented, as described in greater detail below.

In FIG. 2, central screen 230 shows a representation of a vault 232. Vault 232 is shown to a participant before and between challenges that are presented in central screen area 230 during the course of a round. Vault 232 includes dynamic visual features that provide information regarding a participant's progress through one or more rounds of Gold Rush™. These visual features include a round number 245 that identifies the round in which the participant is currently participating (i.e. round “8” in the embodiment of FIG. 2), a latch arm 240 that moves to a challenge indicator number when that challenge is about to be displayed in central screen 230, and 12 challenge indicators 234 (one for each of the 12 preliminary challenges in a round). Each challenge indicator 234 includes a challenge number and a status indicator for that challenge. In the embodiment of FIG. 2, the status indicator of challenge indicator 234 has three states: one indicating that a challenge is “locked” (not yet available), one indicating that a challenge is “unlocked” but not yet solved, and a third indicating that the challenge has been solved. In the embodiment of FIG. 2, the status indicator for the “locked” state is an image of a red light. The status indicator for the “solved” state is a green light together with the word “Solved.” The status indicator for an unlocked-but-not-yet-solved state is a neutral, gray light. In FIG. 2, all 12 challenges are shown as being in the unlocked-but-not-yet-solved state. Latch arm 240 is positioned at the challenge indicator for challenge number 1, indicating that challenge number 1 is about to be presented to the participant.

In addition to central screen 230, interface 200 of FIG. 2 includes additional interface elements that provide status information to a participant and that allow a participant to navigate among rounds and challenges, and to search for information to help solve challenges. These additional interface elements include round selection bar 235, challenge selection bar 205, status summary indicator 210, round status indicator 215, challenge release schedule indicator 220, and clue search bar 225.

Round selection bar 235 allows a participant to select a desired round in which to attempt to solve challenges. In the embodiment of FIG. 2, only the currently released round is used to select contestants for the associated competition. However, earlier rounds are available to a participant if the participant would like to attempt to solve earlier challenges for practice or simply for the fun of solving the challenges.

In the embodiment of FIG. 2, round selection bar 235 includes numerals 1 to 12 representing twelve $100,000 rounds and the phrase “MILLION $ ROUND” representing the thirteenth, $1,000,000 round. Rounds for which challenges are currently available are shown in a light font color, rounds for which challenges are no yet available are shown by a dark font color. In FIG. 2, the numerals representing rounds 1 to 9 are shown in a light font color. Accordingly, challenges are available for rounds 1 to 9. The numerals representing rounds 10 to 12, however, and the term “MILLION $ ROUND” are shown in a dark font color. Accordingly, in the embodiment of FIG. 2, challenges for rounds 10 to 13 are not yet available. A circle indicates the currently selected round. In FIG. 2, the currently selected round is indicated by a circle around round number “8.”

Challenge selection bar 205 allows a participant to select an available challenge to solve. Challenge selection bar 205 includes selection buttons for each of the 12 preliminary challenges and for the “Gold Challenge” selection challenge for the currently selected round. In the embodiment of FIG. 2, the selection button for each preliminary challenge 1 to 12 comprises an image of gold bar containing the word “Play,” indicating that each of the preliminary challenges is available and may be selected for “play” by the participant. When a challenge has been solved, the word “Play” is replaced by the word “Solved,” providing the participant a visual indication of the challenges that have been solved for the current round.

When a participant selects a new round, the default is that the first unsolved and available challenge for that round is presented to the participant. However, the participant can manually select any of the available challenges shown in challenge selection bar 205.

Status summary indicator 210 comprises an area of interface 200 that provides a summary to a participant of the number of challenges and rounds that the participant has completed. Status summary indicator 210 also indicates the screen name of a participant. In the embodiment of FIG. 2, status summary indicator 210 indicates that the screen name of the current participant is “PATENTAPP”, and that the current participant has not yet solved any challenges or completed any rounds.

Round status indicator 215 comprises a portion of interface 200 that provides status information about the currently selected round. In the embodiment of FIG. 2, the status information includes the round number and location (i.e. city) of the offline competition for that round, the number of available preliminary challenges for that round, the number of preliminary challenges that the participant has completed, the number of preliminary challenges for the current round that are still locked, and the status of the “Gold Challenge” for the round. In FIG. 2, the round is identified as “Round 8.” The location for the offline competition for which contestants are being selected is identified as “Albuquerque.” The number of available preliminary challenges for Round 8 is indicated as “12.” The number of completed preliminary challenges is indicated as “0.” The number of locked preliminary challenges is indicated as “0.” The status of the Gold Challenge is indicated as “Locked.”

Challenge release schedule 220 comprises a portion of interface 200 that provides information about the upcoming release of challenges for the current and/or upcoming rounds. Clue search bar 225 allows a participant to enter search terms to search for internet webpages that contain information that will help solve a challenge. In the embodiment of FIG. 2, terms entered in clue search bar 225 are submitted to a general purpose web search engine, and the search results are displayed to the participant in a new browser window.

Interface 200 also includes numerous other interface elements, including advertising banners and links to other webpages.

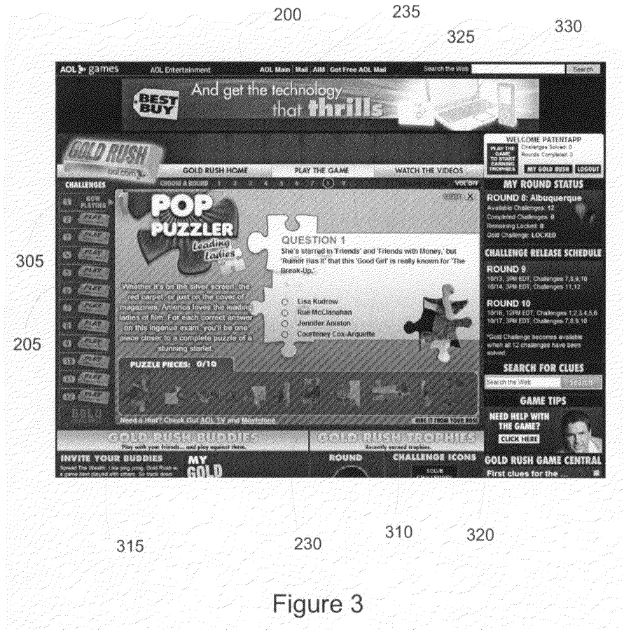

FIG. 3 shows an embodiment of a challenge that is presented to a participant of Gold Rush™. The challenge is presented to the participant in central screen 230 of interface 200. In challenge selection bar 205, the words “Now Playing” are displayed adjacent to the indicator 305 for challenge number “1.” In round selection bar 235, round number “8” is indicated by a circle. Accordingly, the challenge shown in central screen 230 of FIG. 3 is challenge number “1” of round “8.” Also, in FIG. 3 the challenge selection buttons of challenge selection bar 205 have been “grayed out,” indicating that a new challenge cannot be selected while a current challenge is being displayed in central screen 230. In the embodiment of FIG. 3, the current challenge must first be “closed” by selecting close button 330 before a different challenge can be selected from challenge selection bar 205.

The challenge shown in FIG. 3 is called “Pop Puzzler—Leading Ladies.” In this challenge, a series of questions are asked about popular actresses. Each question has a puzzle piece associated with it. In the embodiment of FIG. 3, there are ten puzzle pieces, as shown in a puzzle piece display area 310 disposed along the bottom edge of central screen 230. A puzzle piece status indicator 315 above puzzle piece display area 310 indicates the number of puzzle pieces the participant has currently earned (by answering the associated questions correctly). Questions together with multiple choice answers are presented one at a time in question area 325. In FIG. 3, the question that is displayed is labeled “Question 1.” For each question displayed in question area 325, the corresponding puzzle piece 320 is also displayed.

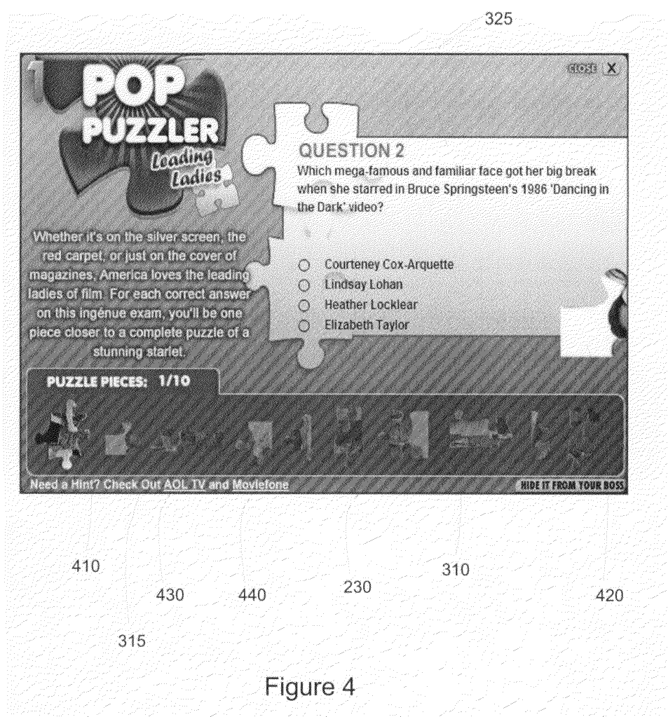

If the participant selects the correct answer to a question, the word “correct” flashes on central screen 230, the puzzle piece corresponding to that question is highlighted in puzzle piece display area 310, and the next question is presented in question area 325. FIG. 4 shows central screen 230 of FIG. 3 after the question displayed in question area 325 of FIG. 3 (i.e. “Question 1”) is correctly answered by the participant. In FIG. 4, puzzle piece 410 corresponding to Question 1 is highlighted in puzzle piece display area 310 (indicating that the participant has “earned” that puzzle piece by answering the associated question correctly), and puzzle piece status indicator 315 has been incremented to indicate that a puzzle piece has been earned. Also, in FIG. 4, Question 1 has been replaced by the next question (“Question 2”) in question area 325, and its corresponding puzzle piece 420 is displayed.

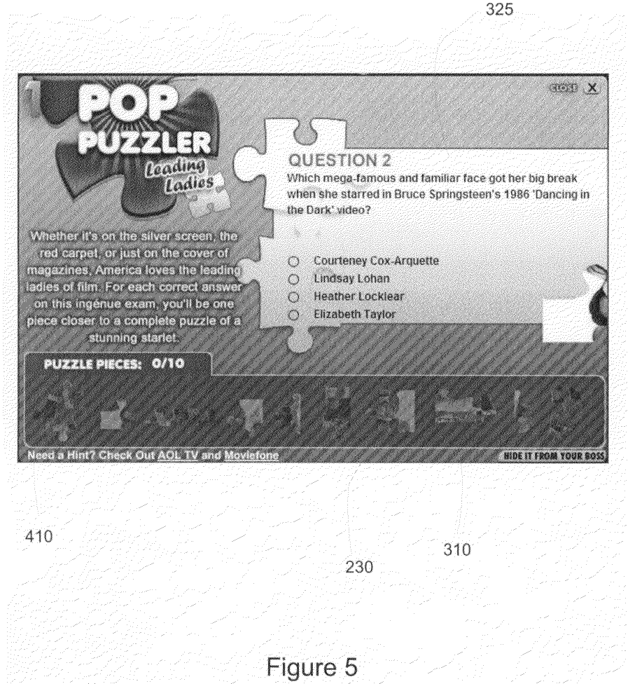

As described above, FIG. 4 shows an embodiment of central screen 230 that is presented to a participant if the participant selects the correct answer to Question 1 of FIG. 3. FIG. 5, on the other hand, shows an embodiment of central screen 230 that is presented to a participant if the participant selects an incorrect answer to Question 1 of FIG. 3. If a participant selects an incorrect answer, the word “incorrect” flashes on central screen 230 and, as in FIG. 4, the next question is presented in question area 325. However, because the participant answered Question 1 incorrectly, and therefore did not “earn” the puzzle piece associated with Question 1, puzzle piece 410 remains “grayed out” in FIG. 5, and puzzle piece status indicator 315 continues to indicate “0” pieces earned. In the embodiment of FIG. 5, once all questions associated with puzzle pieces are presented, any questions the participant answered incorrectly are again presented to the participant in the order originally presented. Questions continue to be presented to the participant until all questions have been answered correctly, and all available puzzle pieces have been “earned” by the participant.

In one or more embodiments of the invention, search tools are presented to a participant to allow the user to search other webpages and websites for information to help solve a challenge. For example, in the embodiment of FIG. 4, links 430 and 440 are provided that direct a user to webpages of AOL TV and Moviefone. At those webpages, a participant may search for information about TV shows and movies to help solve a question. By driving participants via the “hint” links 430 and 440 to the associated target webpages, traffic to those webpages is generated that can be the source of advertising revenues for the entity or entities presenting Gold Rush™. Hint links 430 and 440 may be also used to advertise services provided by the presenting entities themselves. For example, in the embodiment of FIG. 4, hint link 430 directs participants to another service (“AOL TV”) of AOL, which is also presenting Gold Rush™ to participants.

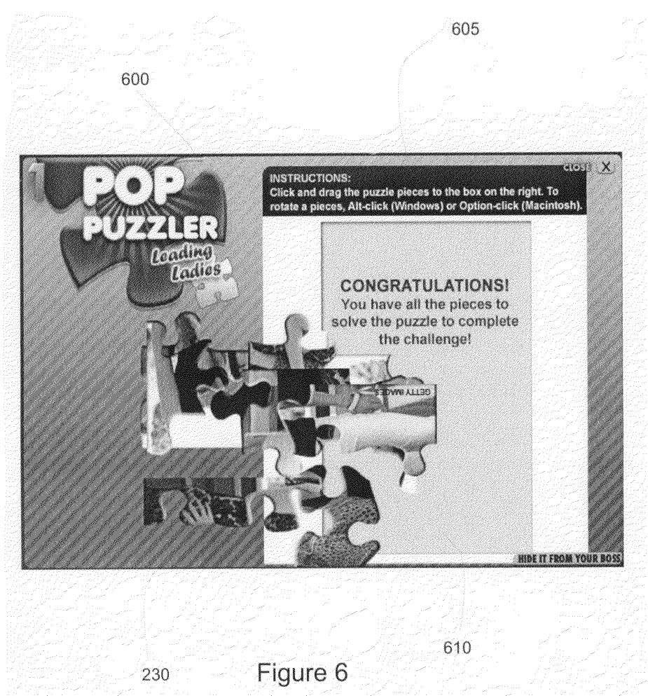

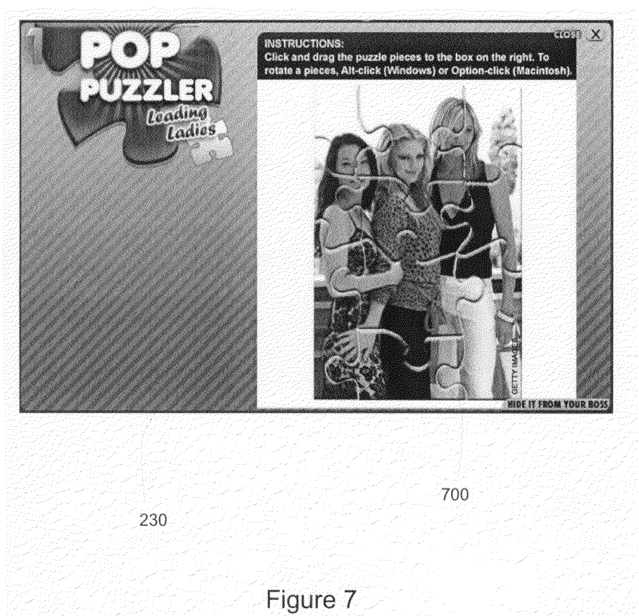

FIG. 6 shows an embodiment of an interface that is presented to a participant in central screen 230 when the participant has answered all questions of the “Pop Puzzler” challenge correctly and has earned all the puzzle pieces. The interface of FIG. 6 includes a representation of an overlapping pile of puzzle pieces 600 and a puzzle assembly box 610. The interface of FIG. 6 also includes instructions 605 that state: “Click and drag puzzle pieces to the box on the right. To rotate a piece, Alt-Click (Windows) or Option-Click (Macintosh).” To solve the challenge, a participant must drag the individual puzzle pieces from pile 600 to the appropriate location in puzzle assembly box 610, rotating and positioning them as needed to assemble the puzzle. FIG. 7 shows the resulting completed puzzle 700.

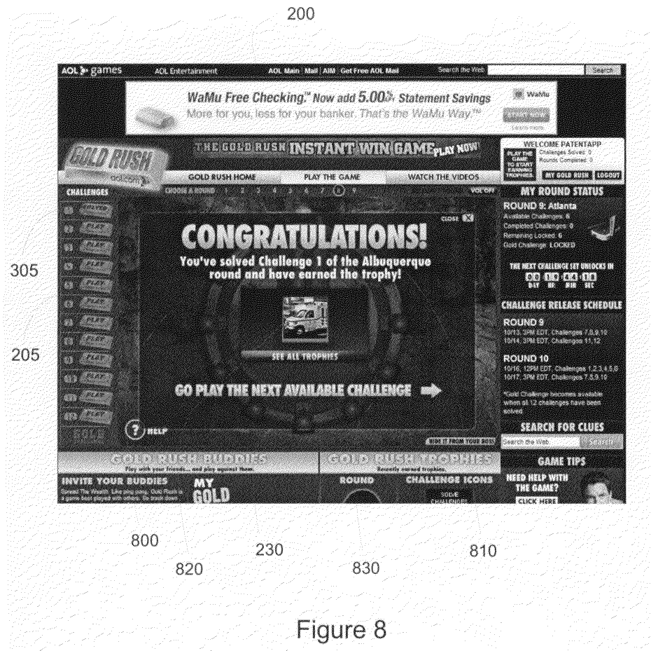

Once a participant arranges the puzzle pieces as shown in FIG. 7, the challenge is completed. In one or more embodiments of Gold Rush™, after a participant successfully completes a challenge, a congratulatory, end-of-challenge screen is displayed to the participant in central screen 230. An example of an end-of-challenge screen 800 presented in one or more embodiments of the invention is shown in FIG. 8.

In the embodiment of FIG. 8, end-of-challenge screen 800 includes a congratulatory message 810, image 820, and a next challenge control 830. Congratulatory message 810 states: “Congratulations! You've solved Challenge 1 of the Albuquerque round and have earned the trophy!” The “trophy” referred to in message 810 is an image 820. In one or more embodiments, the “trophy” images of a round relate to the city in which the offline competition for that round is held. Next challenge control 830, when activated by being clicked-on by the participant, causes the next available challenge of the current round to be presented to the participant.

In the embodiment of FIG. 8, completion of the just-completed challenge is also indicated by changing the caption on challenge selection button 305 for that challenge from “Now Playing” to “Solved.”

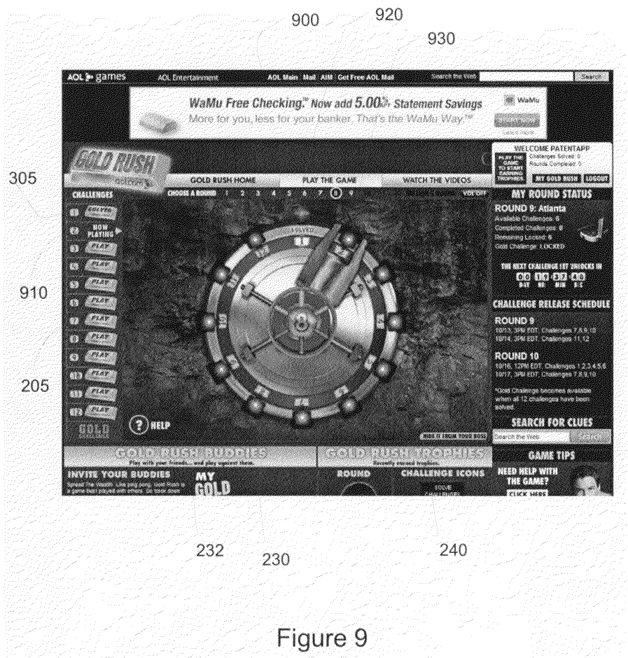

FIG. 9 shows an embodiment of interface 900 that is presented to a participant when next challenge control 830 of the embodiment of FIG. 8 is activated by a participant. Interface 900 depicts a transition between two challenges.

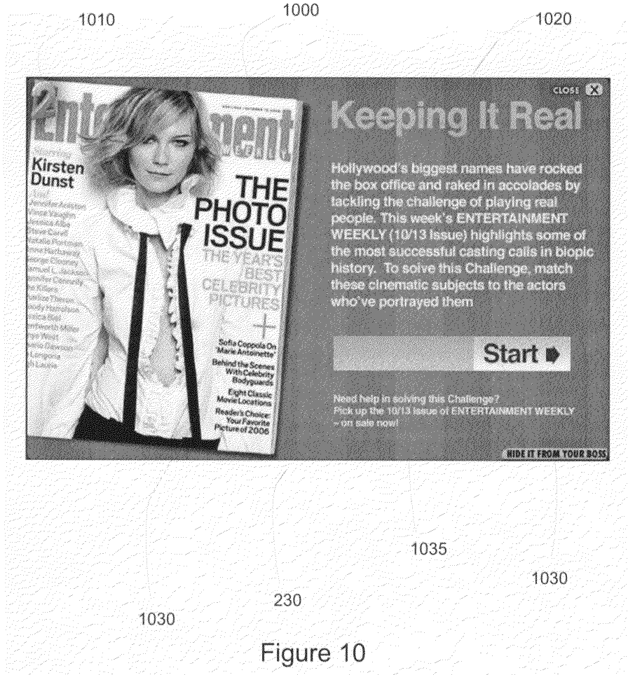

Interface 900 of FIG. 9 presents an animated image of vault 232 in central screen 230 that represents a transition from the just solved challenge (Challenge 1 of Round 8) to the next available challenge (Challenge 2 of Round 8). In central screen 230 of FIG. 9, the status of challenge indicator 920 for Challenge 1 is changed to indicate that Challenge 1 has been solved by depicting a green light and the word “Solved” above the number “1.” An animation of latch arm 240 is presented in which latch arm 240 pivots from challenge indicator 920 for Challenge 1 to challenge indicator 930 for Challenge 2. The caption of challenge selection button 910 in challenge selection bar 205 is changed to indicate that Challenge 2 is “Now Playing.” Then the next challenge is presented in central screen 230, as shown in FIG. 10.

FIG. 10 shows a start screen 1000 displayed in central screen 230. In the embodiment of FIG. 10, a challenge number 1010 is shown in the top left corner of central screen 230 when a challenge is “playing” (i.e. being presented to the participant). In FIG. 1010, challenge number 1010 is the number “2,” indicating that the currently “playing” challenge is Challenge 2 of the currently selected round.

Challenge 2 of FIG. 10 is an example of a challenge provided by one or more embodiments of the invention that is associated with and promotes a particular good or service. The challenge depicted in FIG. 10 is titled “Keeping It Real.” In contains an image 1030 of the front cover of an issue of Entertainment Weekly magazine. Instructions 1020 describe the challenge as follows:
Hollywood's biggest names have rocked the box office and raked in accolades by tackling the challenge of playing real people. This week's ENTERTAINMENT WEEKLY (10/13 Issue) highlights some of the most successful casting calls in biopic history. To solve this Challenge, match these cinematic subjects to the actors who've portrayed them.

FIG. 10 also includes a hint 1035 that states: “Need help in solving this Challenge? Pick up the 10/13 issue of ENTERTAINMENT WEEKLY—on sale now!” Image 1030, instructions 1020, and hint 1035 are examples of elements that are included in one or more embodiments of the invention that provide effective promotional and marketing opportunities for products and services such as Entertainment Weekly magazine as part of the contestant selection process of the invention.

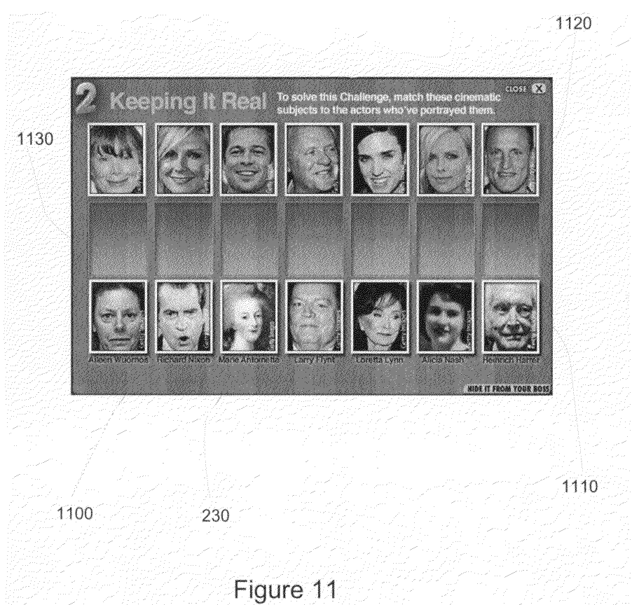

FIG. 11 shows an embodiment of a playing field 1100 that is shown in central screen 230 after start button 1040 of FIG. 10 is activated by a participant. Playing field 1100 includes two rows of images. Bottom row 1110 shows pictures of various real people who have been portrayed by the actors in top row 1120. The goal of the challenge in FIG. 11 is to match the actor to the real person that the actor has portrayed. To do so, the participant must drag an actor's image from row 1120 to the appropriate slot in middle row 1130 that is adjacent to the image of the person in row 1110 that that actor has portrayed.

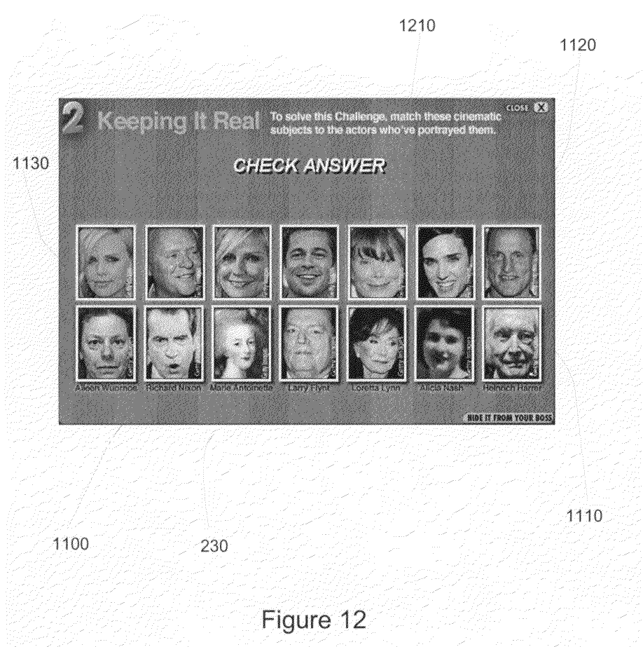

FIG. 12 shows the results of an attempt by a participant to arrange the photos of the actors in row 1120 of FIG. 11 adjacent to the images of the corresponding real persons in row 1110 by placing them in the appropriate slots in row 1130. In the embodiment of FIG. 12, after a participant has filled all of the slots in row 1130, a “Check Answer” control 1210 is displayed on playing field 1100. When the participant activates check answer control 1210 (for example by clicking on it with a mouse), the arrangement of images in row 1130 is checked to determine if the participant has correctly arranged the images, and the result is displayed to the user.

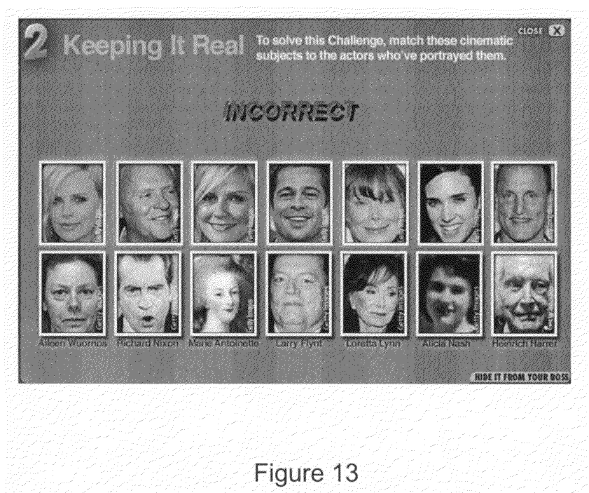

The arrangement of images in row 1130 in FIG. 12 is incorrect. Accordingly, after check answer control 1210 is activated by the participant, a message indicating that the arrangement is incorrect is displayed. One such message is shown, for example, in FIG. 13. In the embodiment of FIG. 13, the word “INCORRECT” is displayed in the general location where “Check Answer” control 1210 was displayed. In one or more embodiments, the word “INCORRECT” comprises the caption of a control button 1310 whose caption changes from “INCORRECT” to “TRY AGAIN” if a mouse cursor is moved over the button. Clicking on control button 1310 causes the starting playing filed arrangement of FIG. 11 to be redisplayed to the participant, allowing the participant to make a new attempt to arrange the images of the actors correctly.

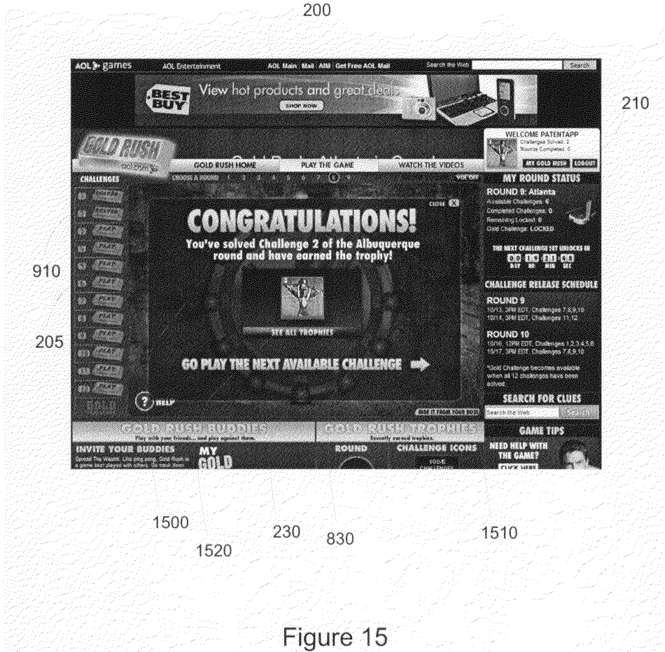

If the arrangement of images in row 1130 is correct when the participant activates “Check Answer” control 1210, a message indicating that the arrangement is correct is displayed, and, shortly thereafter, and end-of-challenge screen, similar to screen 800 of FIG. 8, is displayed in central screen 230. FIG. 15 shows an example of an end-of-challenge screen 1500 that is displayed after the challenge of FIGS. 11-14 has been successfully completed by a participant. As can be seen by comparing end-of-challenge screen 1500 of FIG. 15 to end-of-challenge screen 800 of FIG. 8, end-of-challenge screen 1500 differs from end-of-challenge screen 800 in that congratulatory message 1510 refers to Challenge 2 instead of Challenge 1 in congratulatory message 810, and a different image 1520 is displayed as the “trophy.” In addition, the caption on challenge selection button 910 has been updated to indicate that Challenge 2 has been “Solved.” Also, the information displayed in status summary area 210 has been updated to indicate that the number of challenges that have been solved by the participant is now two (2). As in end-of-challenge screen 800, activating next challenge control 830 initiates a transition to the next available challenge being displayed in central screen 230. In one or more embodiments, a transitional interface similar to interface 900 of FIG. 9 is displayed between challenges.

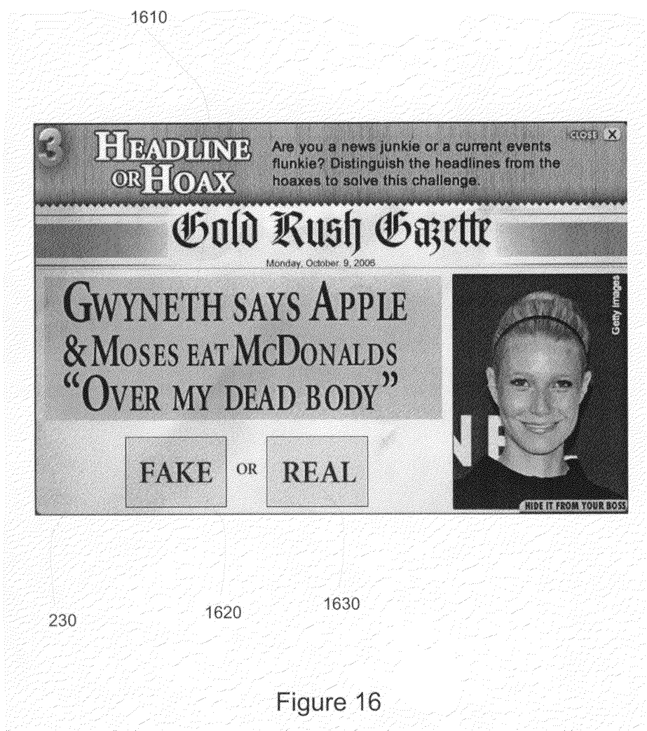

FIGS. 16 to 34 show additional examples of challenges that are presented to participants in one or more embodiments of the invention.

FIG. 16 shows an embodiment of a challenge that is titled “Headline or Hoax.” In the challenge of FIG. 16, a series of headlines such as headline 1610 from a fictional newspaper called “Gold Rush™ Gazette” are displayed. The participant must determine whether the headline is “fake” (i.e. it states something that is not true) or “real” (i.e. it states something that is true) by clicking on the appropriate answer buttons 1620 (“Fake”) or 1630 (“Real”). In the embodiment of FIG. 16, when a participant clicks on either button 1620 or 1630, the message “Correct” or “Wrong” is immediately displayed, then the next “headline” is displayed. Headlines for which the participant has chosen the incorrect answer are displayed again, in seriatim, after all headlines in the challenge have been sequentially displayed. The participant is thus given additional chances to choose the correct answers. In the embodiment of FIG. 16, the challenge comprises a series of 10 headlines, though any other number can be used.

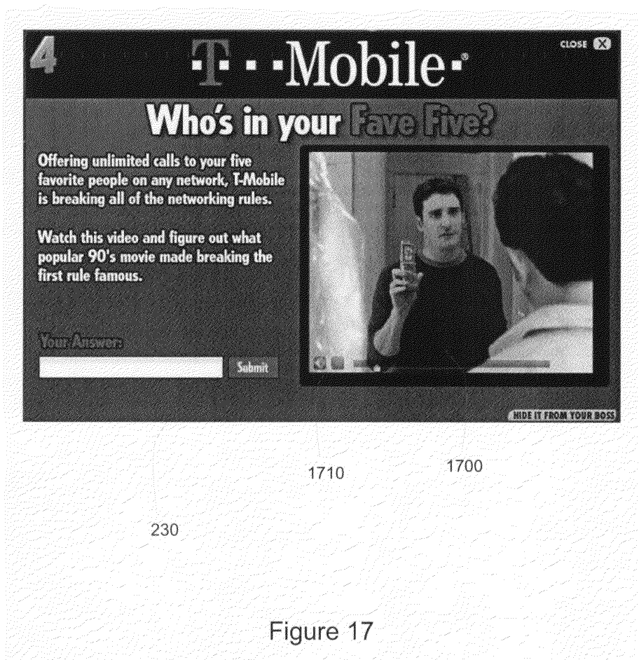

FIG. 17 shows an embodiment of a challenge that promotes a product and/or service. In the embodiment of FIG. 17, the service that is being promoted is the “My Faves” service from T-Mobile, which allows a subscriber to make unlimited calls to five designated phone numbers. The challenge of FIG. 17 includes an on-screen video player 1700 that is configured to show a video clip of a T-Mobile television advertisement for its “My Faves” service. The participant is asked to watch the video clip and “figure out what popular 90's movie made breaking the first rule famous.” To watch the video clip, the participant uses the on-screen play controls 1710 provided by video player 1700. In the video clip, there is a line in which one of the characters says “You don't give another man's girl a foot massage, and you definitely don't put her in your five.” The line about not giving another man's girl a foot massage alludes to a similar line in the 90's movie “Pulp Fiction,” which is the answer to the challenge. Challenge 17 is a very effective advertising medium because in addition to expressly promoting the advertiser's product or service in the text of the challenge, it also provides an incentive to participants (i.e. solving the challenge) to very carefully watch and pay attention to the advertiser's advertisement. This reinforcement is very effective for memory retention of the advertisement and the associated product or service by the participant.

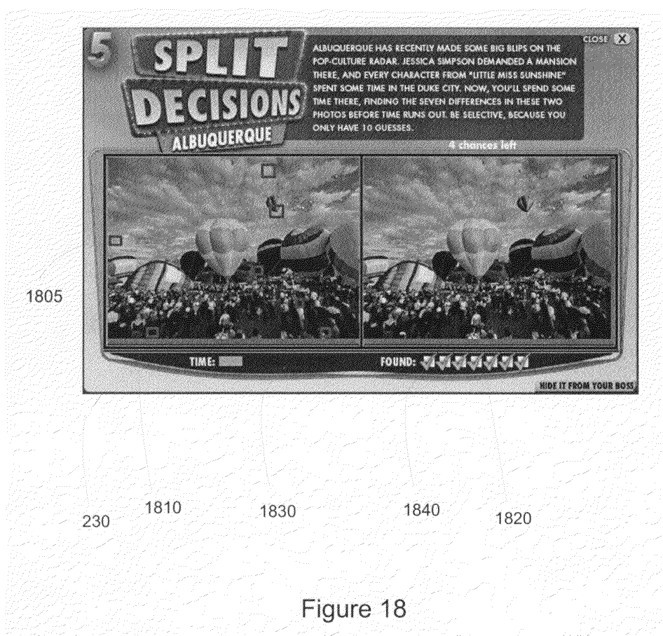

FIG. 18 shows an embodiment of a challenge titled “Split Decisions.” In the challenge of FIG. 18, two images 1810 and 1820 are displayed in central screen 230. The participant is asked to identify differences between the two images, for example by clicking on a feature that is present in one image but absent in the other. If the participant correctly identifies such a difference, a rectangular marker 1805 highlighting that difference is displayed in one of the images, and a check mark is added to the next unchecked box in found status indicator 1840. In the embodiment of FIG. 18, a participant is given a limited amount of time to identify all of the differences between the images. A countdown timer 1810 provides a graphical representation of the portion of time remaining. If a participant does not find all the differences within the time limit, the participant may repeat the challenge as many times as needed.

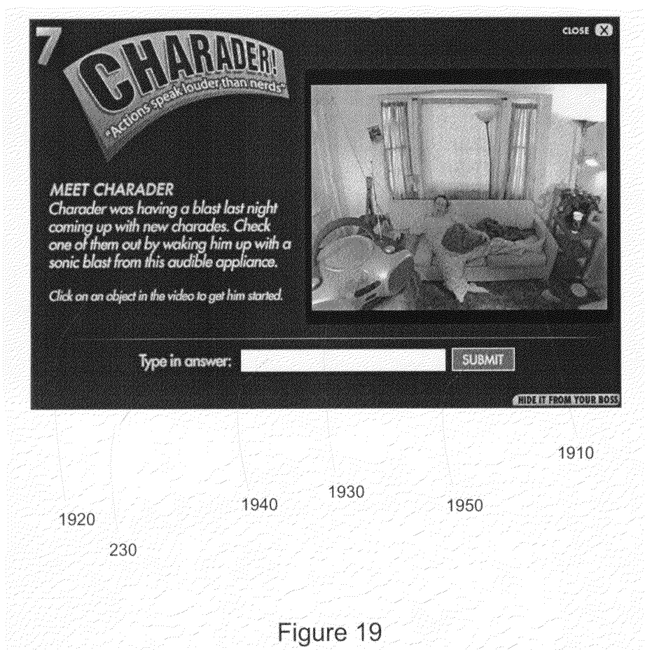

FIG. 19 shows an embodiment of a challenge titled “Charader.” The “Charader” challenge of FIG. 19 displays an on-screen video player 1910 that is configured to show a video clip of an actor who performs a charade. The challenge is to figure out what phrase the Charader is performing.

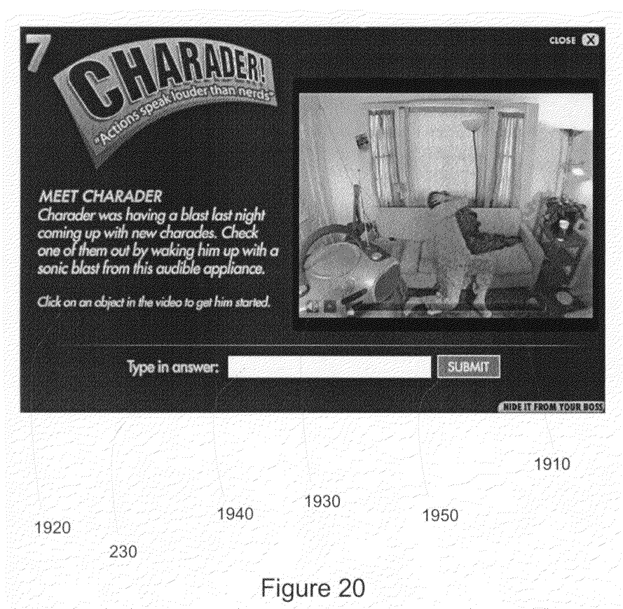

In the embodiment of FIG. 19, video player 1910 initially shows an image of the Charader asleep. Instructions 1920 displayed on central screen 230 instruct the participant to “Click on an object in the video to get him started.” Clicking on an object in the image displayed by video player 1910 causes the video player to begin playing the video clip of the Charader. In the embodiment of FIG. 19, the beginning of the video clip shows boombox 1930 emitting a loud noise, causing the Charader to “wake up,” as shown in FIG. 20. The Charader then performs a charade. The participant can enter guesses as to the meaning of the charade in answer box 1940. Pressing submit button 1950 checks the answer. The outcome of the check (e.g. correct or incorrect) is displayed to the participant. The participant may replay the Charader video clip as often as necessary for the participant to figure out the charade.

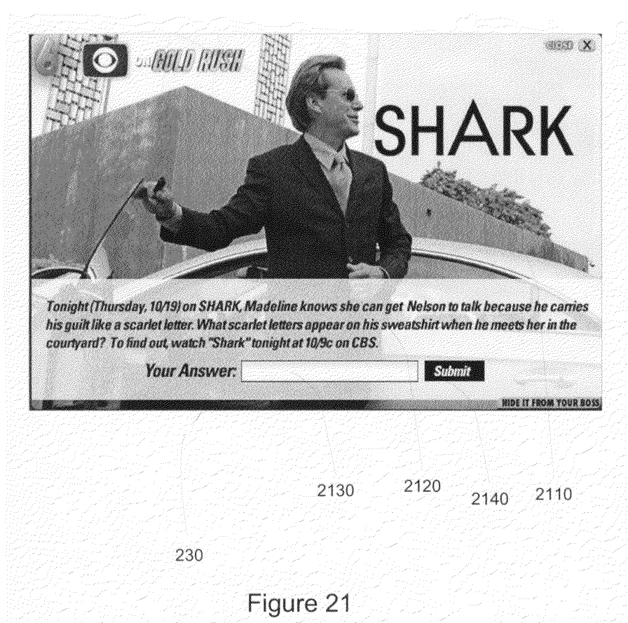

FIG. 21 shows an embodiment of a challenge that asks a question about a television program. In the embodiment of FIG. 21, an image 2110 from the television series “Shark” is shown in central screen 230. The image has a caption 2120 that asks a question about an episode of the television series that has not yet aired, and indicates the date, time, and network on which the television show will be aired. To answer the question, the participant must watch the show and then submit the answer using answer box 2130 and submit button 2140.

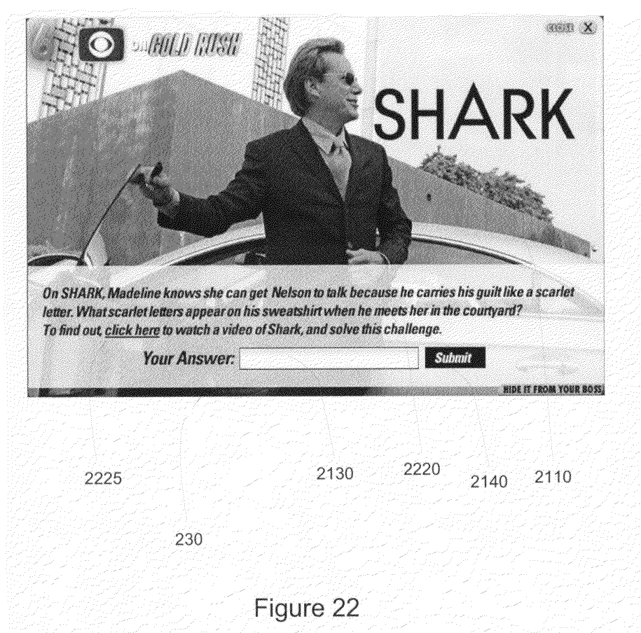

In one or more embodiments, a challenge containing a question about a television show, such as the challenge of FIG. 21, is still available to participants after the time at which the show that is the subject of the question has aired. In one or more embodiments of the invention, after the show has aired, a video clip of a relevant portion of the television program is made available to participants in conjunction with the challenge. FIG. 22 shows the challenge of FIG. 21 as it is presented to participants after the television show that is subject of the challenge has aired. As shown in FIG. 22, caption 2220 has been altered to provide a link 2225 to a video clip of the relevant part of the television program instead of referring to the upcoming broadcast of the program as in FIG. 21.

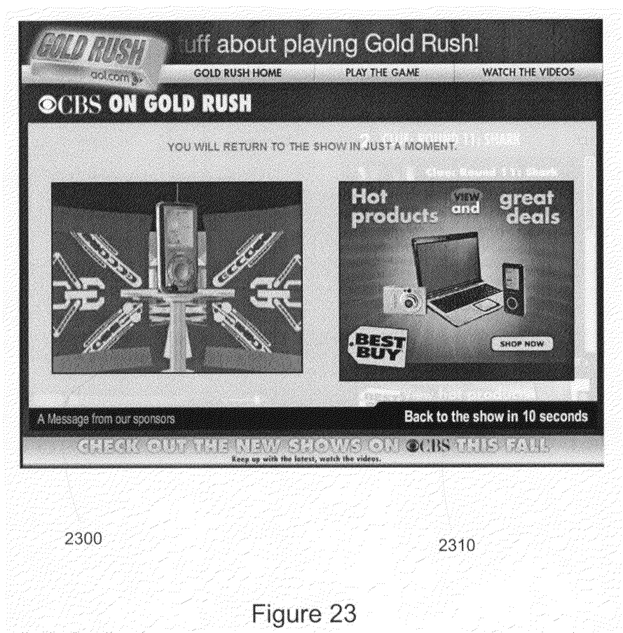

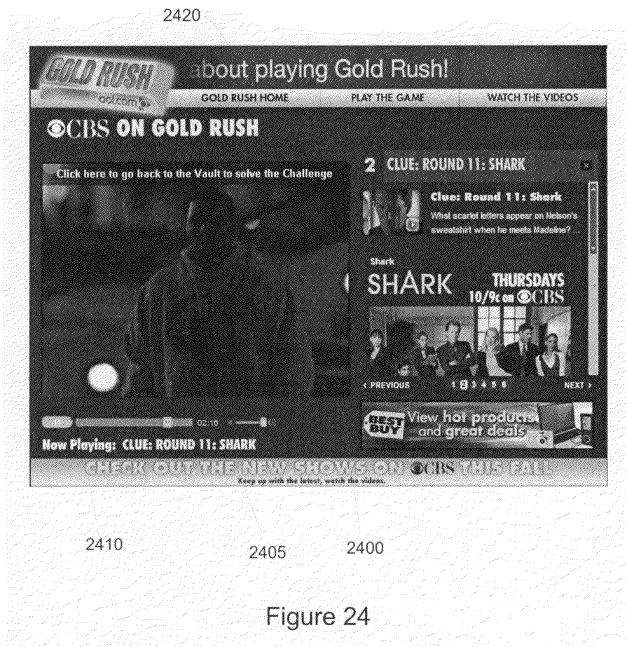

Clicking link 2225 in the embodiment of FIG. 22 will open a new browser in which the participant can view the video clip relating to the challenge of FIG. 22. In one or more embodiments, the webpage opened by clicking link 2225 allows a participant to select for viewing video clips relating to challenges presented in other available rounds of Gold Rush™. In one or more embodiments, after selecting the video to view, the participant is first shown a product or service advertisement. FIG. 23 shows an example of a product advertisement shown to a participant before the selected video clip relating to the challenge the participant is seeking to solve is shown. In the embodiment of FIG. 23, advertisement 2300 includes a countdown timer 2310 indicating the number of seconds before the selected video clip will be shown. Countdown timer 2310 tends to keep the participant's attention fixed on advertisement 2300 during the period of time before the selected video clip is shown. FIG. 24 shows an embodiment of a video player interface 2400 displayed to a participant after advertisement 2300 of FIG. 23 has finished playing. Video player interface 2400 includes a video display area 2405, video player controls 2410, and a return control 2420 that returns the participant to the challenge the participant is currently attempting to solve.

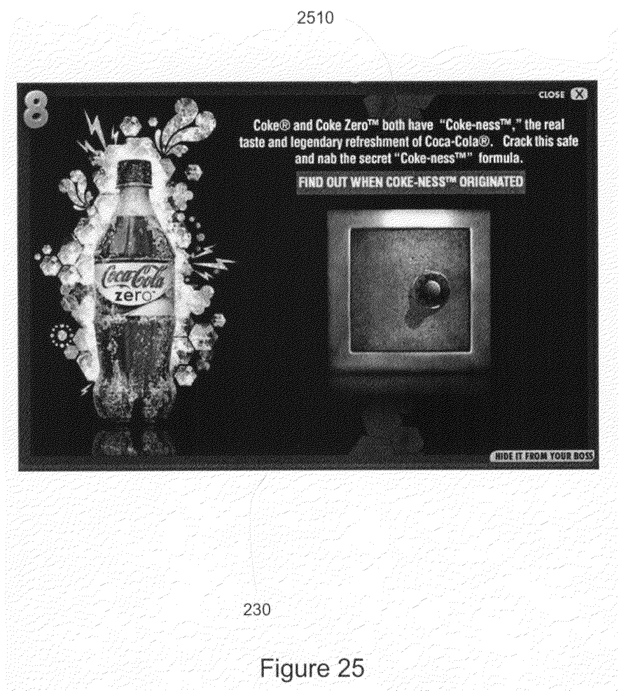

FIG. 25 shows an embodiment of a challenge that asks a question about a particular product or service, requiring a participant who does not immediately know the answer to do research about the product or service in question. A challenge such as challenge 25 promotes the interest of a participant in a product or service by the participant's active and intentional search for information about the product or service.

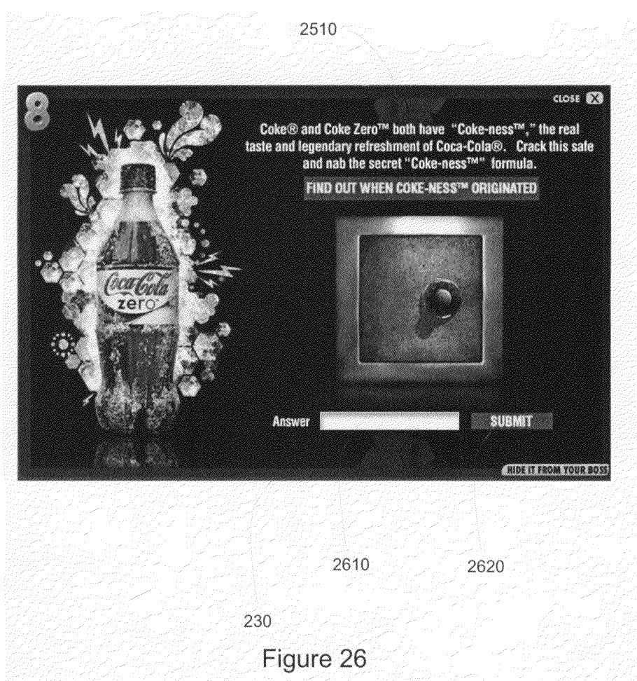

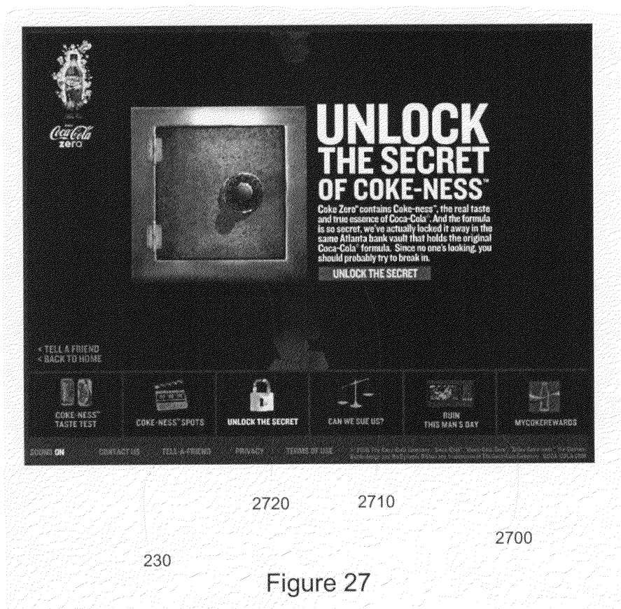

In the embodiment of FIG. 25, the product being promoted is Coca Cola Zero. The participant is challenged by a highlighted banner 2510 displayed in central screen 230 to “Find Out When Coke-ness [which refers to the taste of Coca Cola] originated.” To continue, the participant must click on banner 2510, which comprises an underlying control button. When a participant clicks on banner 2510, two actions occur. As shown in FIG. 26, an answer entry box 2610 and a submit button 2620 are displayed in central screen 230. In addition, a promotional webpage 2700 about Coca Cola Zero, as shown in FIG. 27, is opened in a new browser window. A participant may search for the answer to the challenge by exploring webpage 2700, or by searching for the answer in some other manner. In the embodiment of FIG. 27, webpage 2700 contains a hidden control behind highlighted banner 2710. Clicking on banner 2710 will cause display of an online game whose purpose is to break into safe 2720, which purports to contain the original secret formula for Coke. If the participant is successful in the game, the participant can deduce the year of the original Coke formula, which is the answer to the challenge of FIGS. 25 and 26.

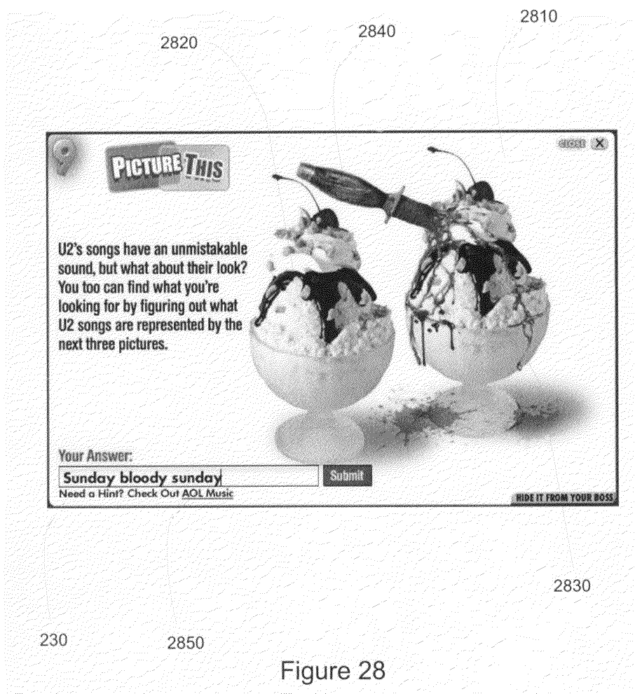

FIG. 28 shows an embodiment of a challenge titled “Picture This.” In the embodiment of FIG. 28, a series of pictures are displayed in central screen 230, and the participant is asked to figure out “what U2 songs are represented” by the pictures. A representative picture 2810 is shown in FIG. 28. It shows a first ice cream sundae 2820 next to a second ice cream sundae 2830 that has a bloody knife 2840 sticking in it. A fan of U2 will discern that the picture 2810 represents the song “Sunday Bloody Sunday.” For participants who are not familiar with U2, a link 2850 is provided to a music related website, namely AOL Music, where the participant can find information about the songs of U2, as well as other artists. Challenge 28 thus promotes the AOL Music website by directing participants to the site to search for music information.

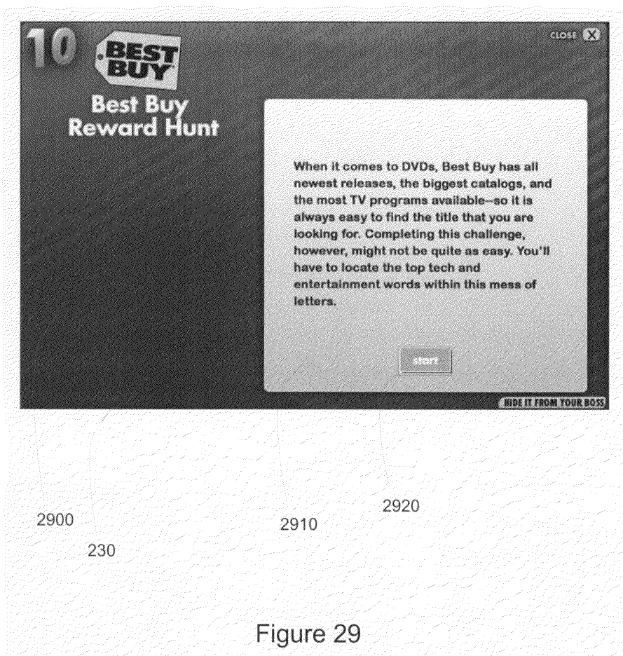

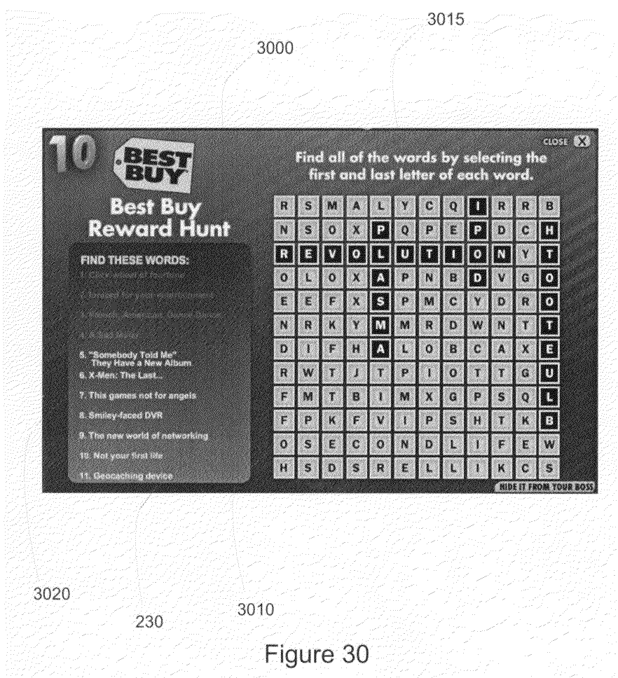

FIGS. 29 and 30 show an embodiment of a challenge sometimes referred to as a “word hunt.” FIG. 29 shows a start screen 2900 that is displayed in central screen 230 at the start of the challenge. Start screen 2900 contains introductory information 2910 explaining that the challenge is related to a particular product or service provider. In the embodiment of FIG. 29, the provider is the technical products store chain Best Buy. Information 2910 explains that the challenge involves “top tech and entertainment words.” To start the word hunt challenge, the participant clicks on start button 2920.

FIG. 30 shows an example of a “word hunt” challenge playing field 3000 displayed in central screen 230 in an embodiment of the invention. Word hunt playing field 3000 includes a 12 by 12 grid of letters 3010, instructions 3015, and hint list 3020. Grid 3010 contains letters arranged in rows and columns, some of which spell words when read up or down along a column or right to left or left to right along a row. Hint list 3020 lists hints for the words that must be found to complete the challenge. Instructions 3015 state: “Find all the words by selecting the first and last letter of each word.” In the embodiment of FIG. 30, the first and last letters must be selected in that order—if the last letter is selected first, the word is not considered to have been selected. The hints (or clues) in hint list 3020 are initially highlighted. When a word is correctly selected by the participant in grid 3010, the hint related to that word is “grayed-out” in hint list 3020. In FIG. 30, the first four words have been correctly selected in grid 3010. Accordingly, the first four hints in hint list 3020 are grayed-out. In the embodiment of FIG. 30, words can be selected in grid 3010 in any order, regardless of the order the related hints are listed in hint list 3020.

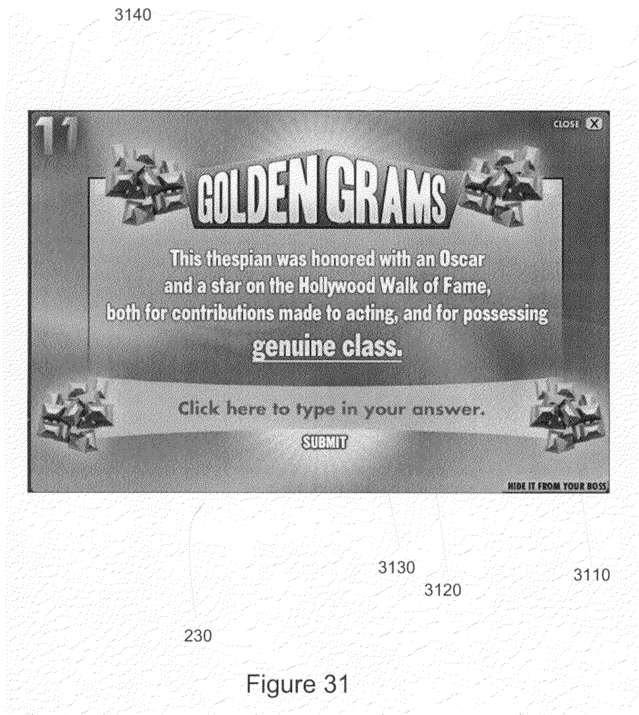

FIG. 31 shows a challenge titled “Golden Grams.” This challenge presents a word clue 3110 from which the participant must derive the answer. In the embodiment of FIG. 31, the word clue states: “This thespian was honored with an Oscar and a star on the Hollywood Walk of Frame, both for contributions made to acting, and for possessing genuine class.” An answer box 3120 and submit button 3130 are provided for submission of a participant's answer. Challenge number 3130 indicates that the challenge of FIG. 31 is the 11^{th} challenge of a round. In one or more embodiments, challenges are designed such that their level of difficulty increases with increasing challenge number. The challenge of FIG. 31 can be solved by searching for an actor who was granted an Oscar for contributions made to acting and who has “genuine class”—namely, has been granted a knighthood. The answer is “Alec Guinness.”

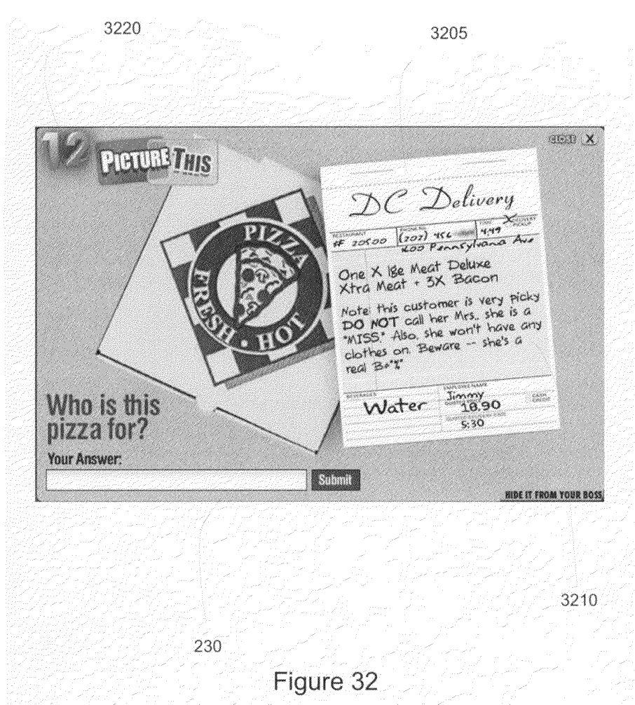

FIG. 32 shows an embodiment of a challenge entitled “Picture This.” The challenge of FIG. 32 is identified by challenge number 3220 as the 12^{th} and therefore last preliminary challenge of the current round. In the embodiment of FIG. 32, solving the last preliminary challenge allows the participant to participate in the selection challenge for the round. In one or more embodiments, the first few participants who complete the selection challenge preliminarily qualify as contestants in the associated competition. The quicker a participant solves the last preliminary challenge, the quicker the participant can begin the selection challenge. Accordingly, although in one or more embodiments, the quickness in solving the last preliminary challenge (and/or the last few preliminary challenges, if they are made available at the same time) is not directly used as criteria in selecting the contestants for the competitions, those participants who solve the last preliminary challenges the quickest have a time advantage in starting the selection challenge.

The challenge of FIG. 32 shows an image of a pizza box 3205 and a delivery ticket 3210 from which the participant is asked to answer the question “Who is this pizza for?” Delivery ticket 3210 contains several clues about the identity of the intended recipient of the pizza. The delivery address is “1600 Pennsylvania Ave,” which is the address of The White House. The pizza is described as an “X large Meat Deluxe” pizza with “Xtra Meat” and “3× Bacon,” indicting that the recipient is a big meat eater. The instructions on delivery ticket 3210 also emphasize that the customer should be called “Mrs.” and not “Miss.” It also states that “she's a real B*‘%’.” An astute participant will figure out that the pizza is intended for a female dog living at The White House whose name begins with “Mrs.”—namely, “Mrs. Beazley”, president Bush's dog.

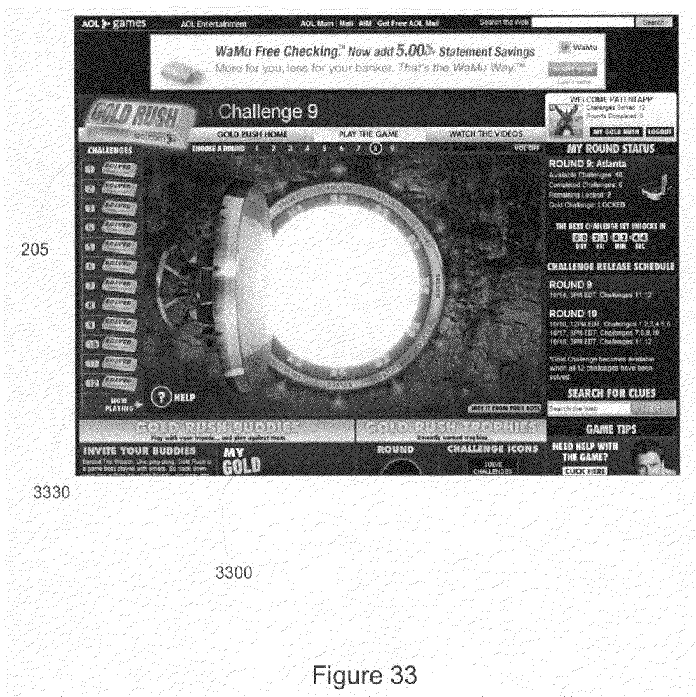

In one or more embodiments, when a participant successfully completes the preliminary challenges for a round, the selection challenge is presented. In one or more embodiments of Gold Rush™, an animated image of a vault opening is displayed to the participant as a transition to the selection challenge, referred to in Gold Rush™ as the “Gold Challenge.” FIG. 33 shows an embodiment of an interface 3300 that is presented to a participant in one or more embodiments of Gold Rush™ after the participant has completed the preliminary challenges for a round and before the “Gold Challenge” selection challenge for the round is presented. As shown on challenge status bar 205 in FIG. 33, the challenges numbered 1 to 12 are listed as “Solved” and the Gold Challenge 3330 is listed as “Now Playing.”

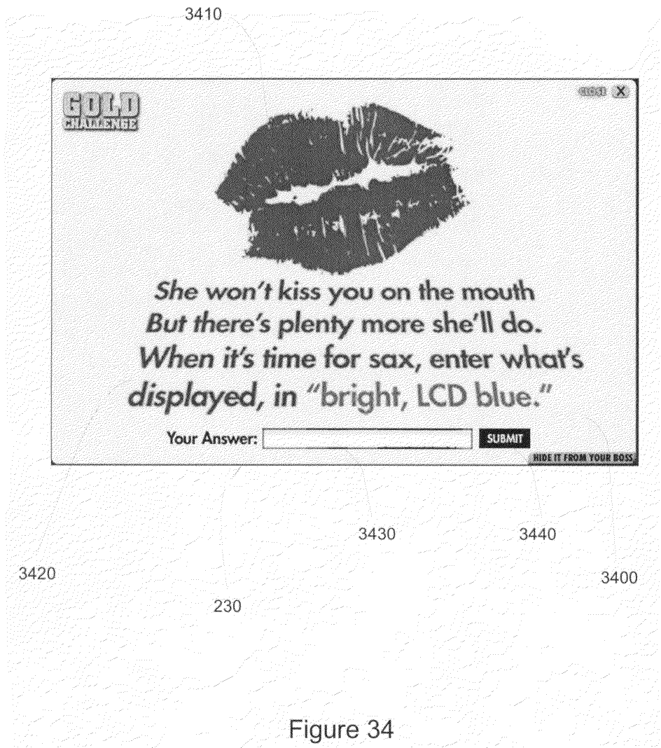

FIG. 34 shows an embodiment of a selection challenge 3400. In one or more embodiments of Gold Rush™, a pre-determined number of participants who complete the “Gold Challenge” for a round the quickest qualify, subject to meeting certain qualifications, to compete in the associated competition for that round.

Selection challenge 3400 of FIG. 34 contains an image 3410 of lips and hint 3420. Hint 3420 states: “She won't kiss you on the mouth But there's plenty more she'll do. When its time for sax, enter what's displayed in ‘bright, LCD blue.” An answer box 3430 and a submit button 3440 are provided.

Hint 3420 refers to a scene in the movie “Pretty Woman” in which saxophone music is played by a radio tuned to the frequency “102.7.” The digits “102.7” are displayed on the radio in blue digits. The answer to selection challenge 3400 is thus “102.7.”

When a participant submits the correct answer to a selection challenge such as challenge 3400 of FIG. 34, the time the answer is submitted is recorded. In one or more embodiments, the time of completion of other challenges besides the selection challenge is also recorded for participants. In one or more embodiments, the times recorded for completion of challenges by a participant can be viewed by the participant by navigating to an appropriate webpage.

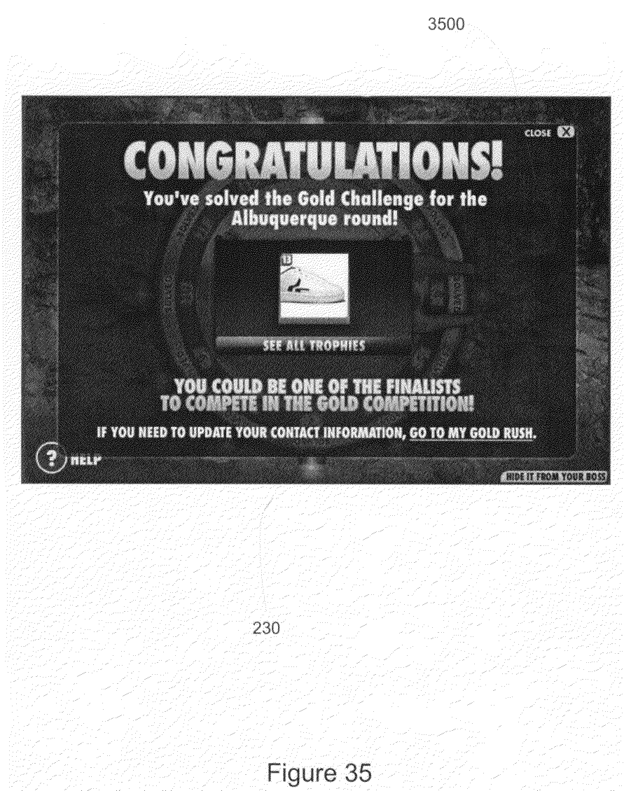

In the embodiment of FIG. 34, successful completion of selection challenge 34 makes a participant eligible for potential selection as a contestant for the associated offline competition, if the participant is one of the few quickest participants in solving the selection challenge. FIG. 35 shows an embodiment of a congratulatory screen 3500 that is displayed to a participant who has completed the selection challenge of FIG. 34. Congratulatory screen 3500 contains a congratulatory message to the participant for solving the “Gold Challenge” and indicates that the participant could be one of the finalists (i.e. contestants) in the offline “Gold Competition.”

In one or more embodiments of the invention, certain types of challenges are repeated, with different specific questions, hint, and answer, in a number of rounds. For example, in Gold Rush™, “Split Decisions” challenges of the type shown in FIG. 18 (using different images), “Charader” challenges of the type shown in FIG. 19 (using different Charader video clips comprising different manners of waking up the Charader and featuring different charades), word hunts of the type shown in FIG. 30, puzzle challenges of the type shown in FIG. 3, and picture riddles of the type shown in FIG. 28, among others, are used in a number of rounds.

In one or more embodiments of the invention, in addition to providing hints as parts of the challenges themselves, additional hits may be provided either on the website on which the challenges are presented, on websites of third parties, in other media such as newspapers, television shows, and magazines, or on or in conjunction with products and services. In one or more embodiments, these additional hints provide mechanisms for promoting services and products, and for generating additional advertising revenues

An embodiment of the invention has been implemented as part of a promotion for the animated film “Flushed Away,” which opened in November 2006. In the Flushed Away promotion, called “The Flushed Away Underground Adventure,” a series of online challenges are presented to participants via a web site. The online challenges include animated computer games that involve scenes, locations and or characters from the Flushed Away film, which is set in an imaginary underground sewage system. Certain of the challenges also integrate product promotional aspects for products and services other than the Flushed Away film itself in the challenges. For certain challenges, a participant is awarded a digital prize, also referred to as a “digital download,” for successful completion of the challenge. Examples of a digital prize include downloadable prizes such as ring tones, computer display wallpaper, and printable items such as calendars and cut-out-puppets. In addition, upon successful completion of a challenge, a participant is given a clue, in the form of a letter, that can be used to solve a final challenge. Successful solution of the final challenge automatically enters a participant in a sweepstakes competition in which prizes are awarded by random drawing.

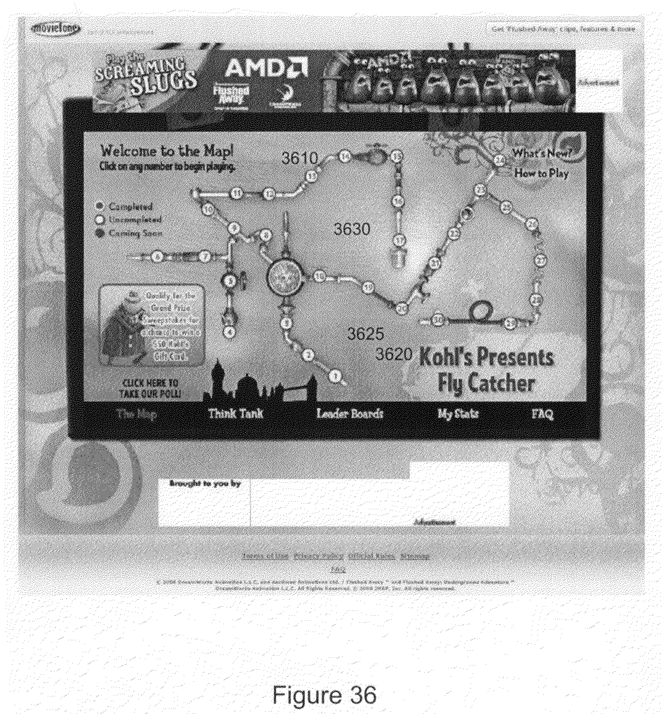

FIGS. 36 to 43 show examples user interfaces in the form of web pages from the “Flushed Away” embodiment of the invention.

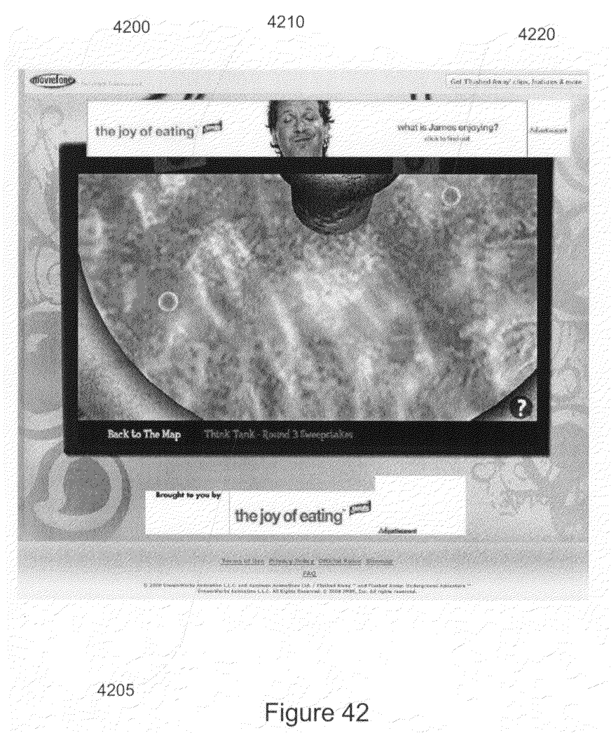

FIG. 36 shows a web page called “The Map.” FIG. 36 shows a map 3600 of a fictional sewer system 3610 that forms part of the environment in which the “Flushed Away” film is set. Map 3600 allows a participant to navigate among available challenges. Numbered circles, such as circle 3620, along sewer system 3610 represent challenges that can be solved by participants. In one or more embodiments, the position of the circle for a challenge indicates the location in the virtual sewer system environment in which the challenge may be set. In FIG. 36, there are 30 total challenges, numbered 1 to 30. Also shown in FIG. 36 is a feature 3630 called the “Think Tank.” The function of the Think Tank will be described with respect to FIG. 42 below. In one or more embodiments, clicking on one of the numbered circles causes an introductory web page for the corresponding challenge to be displayed.

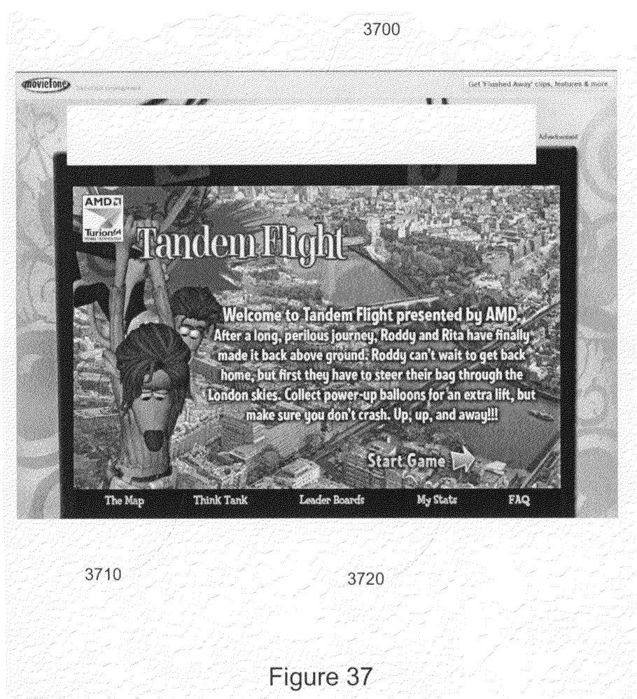

FIG. 37 shows an embodiment of a web page 3700 that is displayed if a participant clicks on circle 3625 representing challenge number 2 on the map 3600 of FIG. 36. Web page 3700 includes an information area 3700 that provides information on the context of the challenge in relation to the characters and setting of the Flushed Away film. Web page 3700 also includes a “Start Game” button 3710 that allows a participant to begin the challenge.

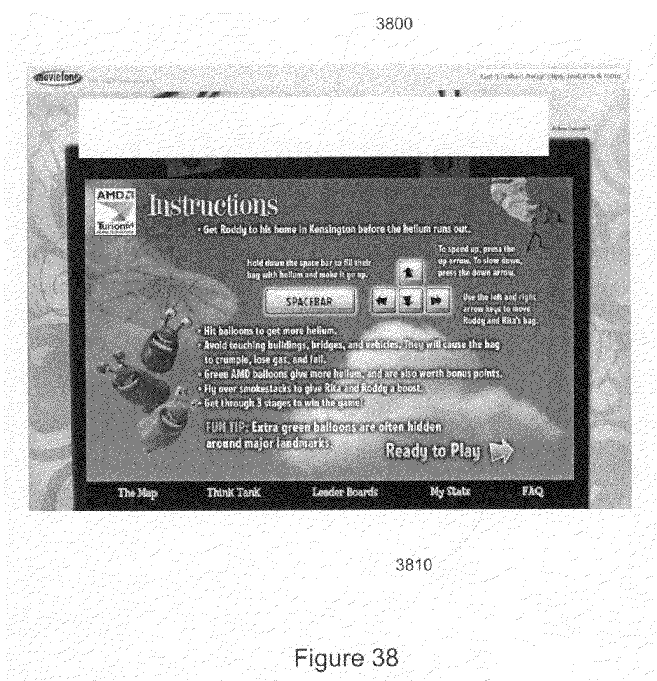

FIG. 38 shows a start screen 3800 for a challenge that is displayed after a participant clicks on “Start Game” button 3710 of FIG. 37. Start screen 3800 provides instructions to a participant on the goal and operation of the challenge. In the embodiment of FIG. 38, the challenge is a computer game that involves a manipulating an image of a hot air balloon from which two of the characters from the film are suspended by the use of certain computer keyboard buttons so as to allow the balloon to avoid obstacles and reach an intended destination. Safely reaching the intended destination constitutes one way to successfully complete the challenge. Start screen 3800 includes a “Ready to Play” button 3810 that starts the game.

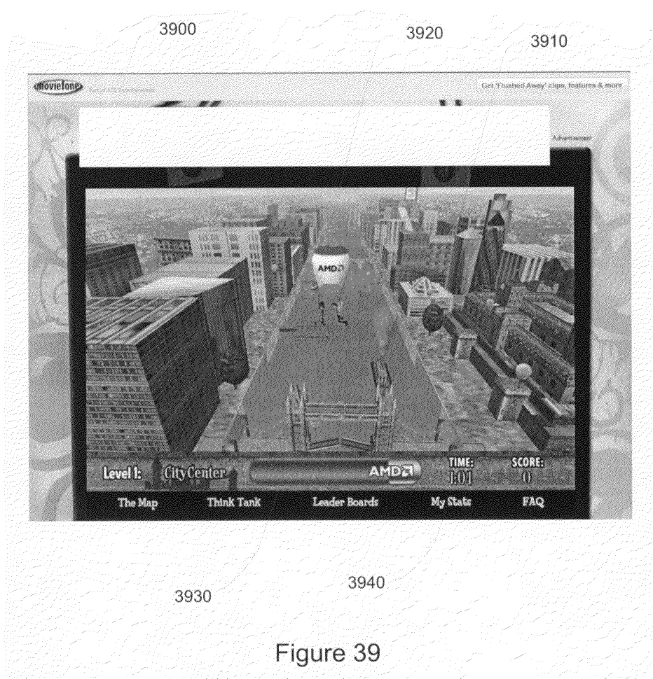

FIG. 39 shows an embodiment of a web page 3900 that is displayed to a participant after the participant clicks the “Ready to Play” button 3810 of FIG. 38. Web page 3900 includes an animated image 3910 that constitutes the computer game that forms the challenge. In the embodiment of FIG. 39, a participant attempts to manipulate the balloon 3920 using keyboard commands to avoid obstacles such as the tower bridge 3930 and to proceed to the intended destination. In one or more embodiments, a participant has a limited amount of time in which to complete the challenge. Thus, web page 3900 includes a time indicator 3940 that displays remaining time available to complete the challenge. In the embodiment of FIG. 39, a sponsor logo is included in the graphic representation of balloon 3920.

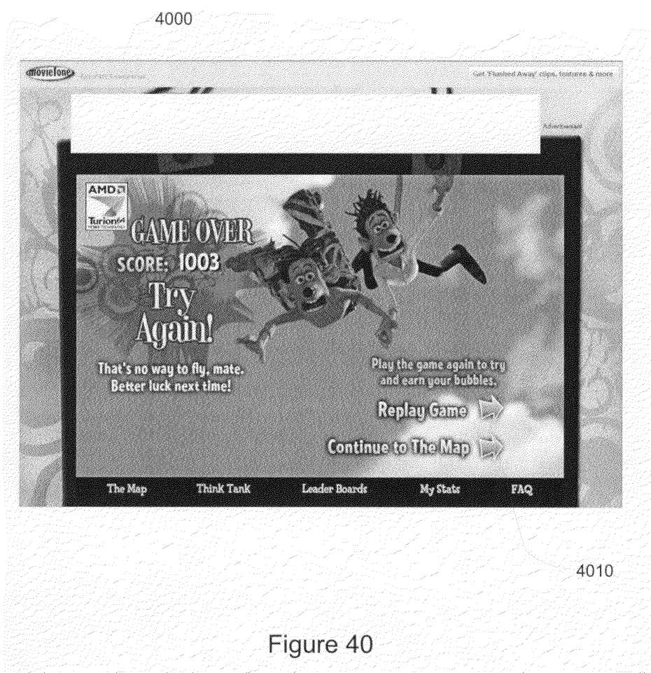

FIG. 40 shows a web page 4000 that is displayed in one or more embodiments if a participant does not successfully complete the challenge of FIG. 39 within the allotted time. FIG. 40 includes a “Replay Game” button 4010 that allows a participant to repeat the challenge.

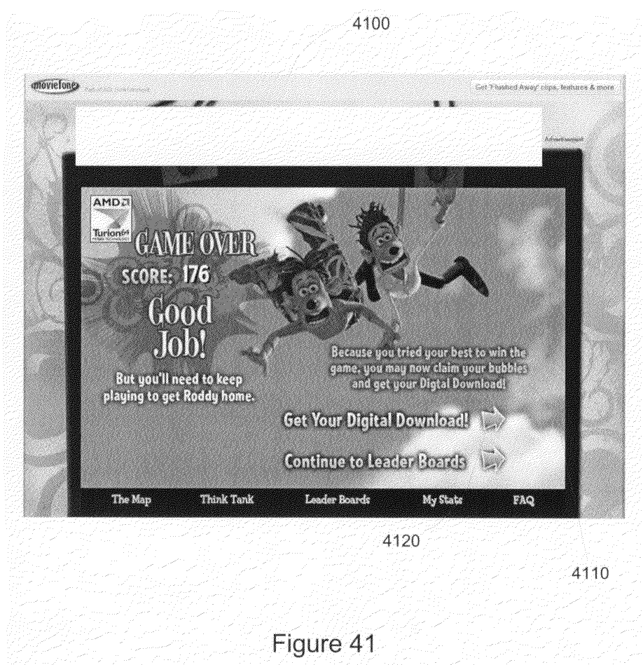

In one or more embodiments, a participant is deemed to have completed a challenge successfully if the participant makes several unsuccessful attempts. FIG. 41 shows a web page 4100 that is displayed in one or more embodiments if a participant has made several unsuccessful attempts to complete the challenge of the computer game of FIG. 39. Web page 4100 includes a notification 4110 that informs that participant that because the participant tried his or her best to win the game, the participant is deemed to have successfully completed the challenge and can “claim [his or her] bubbles” and “get [his or her] Digital Download.”

In the Flushed Away embodiment of the invention, “bubbles” and a “digital download” are awarded to a participant upon successful completion of a challenge. The “bubbles” are images of bubbles that are shown in a representation of a water fountain or tank referred to as a “Think Tank.” FIG. 42 shows an example of a depiction of a Think Tank 4205 in an embodiment of the invention. In the embodiment of FIG. 42, Think Tank 4205 contains two “bubbles” 4210 and 4220. In one or more embodiments of the invention, one or more “bubbles” are added to the Think Tank each time a participant successfully completes a challenge. In one or more embodiments of the invention, the bubbles can be “popped” by clicking on them with a mouse. In one or more embodiments, “popping” a bubble reveals a letter in the bubble. In one or more embodiments, the letters revealed by popping all the bubbles for all challenges itself comprises a challenge, in that the letters can be rearranged into a word or phrase. In one or more embodiments, the phrase that results from the correct rearrangement of the letters from all the bubbles constitutes a question about the Flushed Away film that itself comprises a final challenge that can be answered by watching the film. In one or more embodiments, successfully completing the final challenge enters the participant in a sweepstakes drawing for one or more prizes. In one or more embodiments, the prizes in the sweepstakes drawing are “real” prizes (for example a vacation trip or a money prize) as opposed to the “digital download” prizes that a participant receives for successful completion of individual challenges.

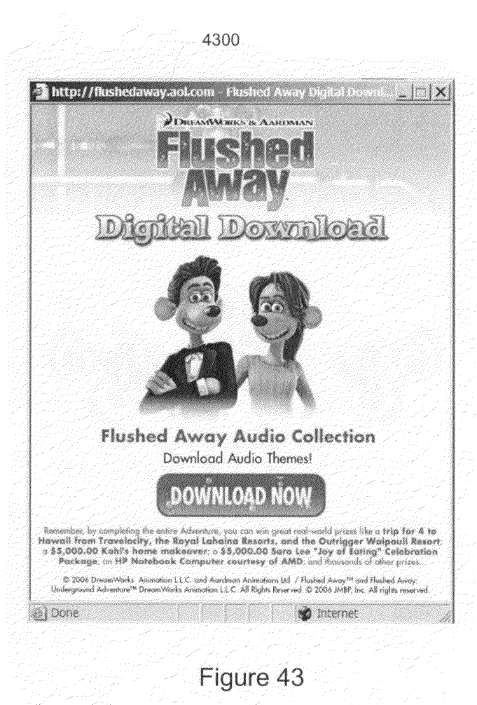

FIG. 43 shows an example of a web page 4300 that is displayed after a participant clicks the “Get Your Digital Download” button 4120 of FIG. 41. In the embodiment of FIG. 43, the digital download is a collection of audio themes related to the Flushed Away film. Other embodiments of digital downloads that are awarded to participants upon completion of individual challenges in the Flushed Away embodiment of the invention include printable downloads such as coloring book pages, a dance guide, bookmarks, a mobile, a French language certificate, a book excerpt, picture frames, jigsaw puzzles, a maze, recipe cards, calendars, character masks, shopping list forms, stationary, finger puppets, and t-shirt iron-ons; and computer related downloads such as avatars, screen savers, wallpaper, and icons, all having some relation to scenes, characters, settings, or actions that take place in the Flushed Away film, and/or to advertising sponsors of the online competition.

Thus, a novel method and system for selection of contestants for competitions has been described. It will be understood that the above described embodiments are merely illustrative, and modifications may be made without departing from the scope of the invention as defined in the claims.

1. A method for selecting a contestant for a competition comprising the steps of:
providing a plurality of first online challenges having first solution criteria;
determining whether said contestant has successfully completed said plurality of first online challenges;
providing a second online challenge to said contestant if said contestant has successfully completed said plurality of first online challenges;
selecting said contestant for said competition based on said contestant's success in completing said second online challenge.

2. The method of claim 1 wherein said first solution criteria comprises objective solution criteria.

3. The method of claim 1 wherein said step of selecting said contestant comprises determining said contestants relative success compared to other contestants in completing said second online challenge.

4. The method of claim 1 wherein said contestant is automatically selected for said competition upon successful completion of said second online challenge.

5. The method of claim 1 wherein said competition comprises an offline competition.

6. The method of claim 5 wherein said offline competition comprises a sweepstakes drawing.

7. The method of claim 5 wherein said offline competition comprises a face-to-face competition among a plurality of contestants.

8. The method of claim 3 wherein said relative success comprises a time of completion of said second online challenge.

9. The method of claim 1 wherein successful completion of a first online challenge comprises achieving a goal for said first online challenge.

10. The method of claim 1 wherein successful completion of a first online challenge comprises making a plurality of attempts to achieve a goal for said first online challenge.

11. A method for promoting a sponsor's product comprising the steps of:
providing an online challenge comprising subject matter as part of a contestant selection process for a competition;
providing information about said sponsor's product as a part of said subject matter of said challenge;
requiring a participant to utilize said information about said product to successfully complete said challenge.

12. The method of claim 11 wherein said sponsor's product comprises a service.

13. The method of claim 11 wherein said challenge comprises a game.

14. The method of claim 11 wherein said competition comprises an offline competition.

15. A method for promoting a film comprising the steps of:
providing at least one first online challenge comprising subject matter from the film as part of a contestant selection process for a competition;
providing at least one second challenge upon successful completion by a participant of said at least one first online challenge;
requiring said participant to utilize information from said film to successfully complete said second challenge.

16. The method of claim 15 further comprising the step of entering said participant in a competition upon successful completion by said contestant of said second challenge.

17. The method of claim 15 wherein said competition comprises a sweepstakes drawing.

18. The method of claim 15 wherein said step of providing at least one first online challenge comprises providing a plurality of first online challenges.

19. The method of claim 15 wherein said at least one first online challenge comprises a computer game comprising subject matter from said film.

20. The method of claim 19 wherein said subject matter from said film comprises at least one of the group consisting of a character, a location, or an object depicted in said film.
